(19) United States
(12) Patent Application Publication
(10) Pub. No.: US 2003/0014475 A1
(43) Pub. Date: Jan. 16, 2003

(54) Data sending device and data sending method

(76) Inventor: Yoko Komori, Kanagawa (JP)

Correspondence Address: William S Frommer, Frommer Lawrence & Haug, 745 Fifth Avenue, New York, NY, 10151, US

(21) Appl. No.: 09/958,799

(22) PCT Filed: Feb. 16, 2001
(86) PCT No.: PCT/JP01/01134

(30) Foreign Application Priority Data
Feb. 16, 2000 (JP) 2000-038544
Feb. 16, 2000 (JP) 2000-038545
Feb. 16, 2000 (JP) 2000-038546

(51) Int. Cl. G06F 15/16

(52) U.S. Cl. 709/200

(57) ABSTRACT

A data transmission apparatus is provided in which a master station (1) for creating playlists indicative of a transmission schedule of materials and slave stations (2-1) to (2-n) for transmitting materials based upon the playlists are connected together via a network (3), the master station (1) includes an attribute imparting means (11) for imparting attributes for instructing a transmission standby to the created playlists and a transfer means (11) for transferring the created playlists and information on attributes imparted to the playlists through the network (3) to the slave stations (2-1) to (2-n) and the slave stations (2-1) to (2-n) include a time setting means (31) for setting a time and a transmission standby means (31) for judging based upon the information on the attributes whether or not the attribute is imparted to the playlist transferred from the master station (1) at this set time and executes a transmission standby based upon the playlist to which this attribute is imparted. The slave station side of the CATV becomes able to execute a transmission standby based upon the playlists distributed from the master station without an operation of a staff member in the broadcasting station.

### TECHNICAL FIELD

The present invention relates to a CATV (cable television) system by which a material made by a CATV broadcasting station in a certain area is distributed to a CATV broadcasting station in another area from which the above material is transmitted.

### BACKGROUND ART

Nationwide, there have been established CATV broadcasting stations whose service areas are limited to the areas of relatively small ranges (e.g., one of cities, towns and villages) these days.

CATV broadcasting stations in the respective areas may sometimes transmit materials (broadcasting programs, etc.) which are originally created by these broadcasting stations, respectively. However, there are not a few cases in which a CATV broadcasting station in a certain area not only transmits its own created materials from its own broadcasting station but also distributes the created materials and a playlist indicating their transmission schedule to a CATV broadcasting station in another area so that the above broadcasting station in another area may transmit the materials in accordance with the playlist (i.e., the former broadcasting station and the latter broadcasting station are placed in a relationship of a master station and a slave station).

When the CATV broadcasting stations in the different areas are placed in a relationship of the master station and the slave station as described above, in order to distribute the material from the master station to the slave station, there has hitherto been employed a method in which materials are re-recorded on a portable medium such as a video tape and in which such portable medium is carried from the master station to the slave station.

Furthermore, when the CATV broadcasting stations in the different areas are placed in a relationship of the master station and the slave station as described above, in order to transmit the material distributed by the master station from the slave station, the slave station side has to execute a transmission standby at the arrival of a transmission trigger (e.g., a fixed time) in a way that the transmission of the materials on the playlist may immediately be started.

As a method of executing the transmission standby on the slave station side, there has heretofore been proposed a method in which a staff member in the slave station confirms every day the playlists distributed from the master station and executes transmission standby operations by a suitable means such as a terminal device if there are materials to be transmitted on that day.

However, an operation for re-recording the materials in the sequential order of the transmission and an operation for carrying the medium to the slave station consume a lot of time and are troublesome inevitably. In particular, when there exist a plurality of slave stations, individual slave stations have to execute these works, which considerably consumes plenty of time and which is very troublesome.

The above transmission standby method imposes a large burden upon the work of the staff in the slave station.

Further, according to this transmission standby method, when a staff member in the broadcasting station and who is in charge of the transmission standby makes a mistake unintentionally (when a staff member fails to notice a material to be transmitted on that day from the playlist and cannot execute suitable operations to effect the transmission standby, when a staff member in the broadcasting station forgets to execute suitable operations to effect the transmission standby or when a staff member in the broadcasting station executes suitable operations to effect the transmission standby after a transmission trigger has been issued), the material to be transmitted on that day cannot be transmitted from the slave station.

Furthermore, with the above transmission standby method, since a staff member in the broadcasting station and who is in charge of the transmission standby has to stay within the slave station, even the slave station which does not produce materials originally but transmits only materials distributed from the master station has been unable to be automated.

As a transmission standby method required when the broadcasting station transmits a created material from its own station, heretofore, there has been proposed a method in which a staff member in the broadcasting station confirms the playlists every day and executes the operations to effect a transmission standby if there exists a material to be transmitted on that day.

Accordingly, a burden imposed upon the work of the staff in the broadcasting station is inevitably large. Moreover, when a staff member in the broadcasting station and who is in charge of the transmission standby makes a mistake unintentionally, a material to be transmitted on that day cannot be transmitted.

On the other hand, independently of the above CATV service, there is now being spread a service for transmitting a material by using a big-screen display installed in the public places (e.g., facilities within railroad stations/airports and the walls of the buildings on the street).

In this transmission service using the display installed in the public place, as a method of distributing a material created at an editing room usually distant from the place in which the display is installed at the place in which the display is installed, there has hitherto been proposed a method such that created materials, for example, are recorded on a cassette tape, which can be recreated by a streamer disposed in the place in which the display is installed, in the sequential order of the materials to be transmitted and the such a cassette tape is carried to the place in which the display is installed.

Accordingly, an operation for re-recording the materials in the sequential order of the materials to be transmitted and an operation for carrying the cassette tape to the place in which the display is installed consume a lot of time and are troublesome inevitably. In particular, when a common material is transmitted by using displays installed in a plurality of places, since these operations have to be done for every display, it takes plenty of time and much labor.

Also in this transmission service using the display installed in the public place, in order to transmit the material, the side of the place in which the display is installed has to execute the transmission standby based upon the playlist in such a manner that the transmission of the materials on the playlists may immediately be started in response to the arrival of a transmission trigger.

As the method in which the transmission standby is executed on the side of the place in which this display is installed, there has hitherto been employed a method in which a person in charge visits the place in which the display is installed every day thereby to confirm the playlists and this person in charge does the operations to execute the transmission standby if there is any material that will be transmitted on that day.

Accordingly, a burden imposed upon an operation of the person in charge is large. Further, when such person in charge makes a mistake unintentionally, the materials that will be transmitted on that day cannot be transmitted any longer. Furthermore, the place in which the display is installed could not be automated constantly.

In view of the aforesaid aspects, it is an object of the present invention to provide a data transmission apparatus and a data transmission method in which materials created by a master station can be distributed to a slave station in a CATV service without consuming a lot of time and much labor. According to the present invention, in a transmission service using a display installed in a public place, the materials created by an editing room can be distributed to the place in which the display is installed without consuming a lot of time and much labor.

Further, in view of the aforesaid aspects, it is an object of the present invention to provide a data transmission apparatus and a data transmission method n which a transmission standby based upon playlists distributed from a master station can be carried out without an operation of a staff member in the broadcasting station in a CATV service. Furthermore, according to the present invention, in a transmission service using a display installed in a public place, the side of the place in which the display is installed becomes able to execute a transmission standby based upon playlists distributed from the editing room without an operation of a person in charge.

Furthermore, in view of the aforesaid aspects, it is an object of the present invention to provide a transmission apparatus and a transmission method in which when a broadcasting station transmits its own created material from its own station, it can execute a transmission standby without an operation of a staff member in the broadcasting station.

### DISCLOSURE OF INVENTION

In a data transmission apparatus according to the present invention in which a data creating section for creating transmitted data and data transmission sections for transmitting the transmitted data are connected together by a network, the data creating section includes a recording and reproducing means on which the created data is recorded, a playlist creating means for creating a playlist for indicating a list of the data recorded on the recording and reproducing means to be transmitted, a selecting means for selecting a playlist to be transferred to the data transmission section from the playlist created by the playlist creating section, an instructing means for instructing the start of the transfer of the playlist and a transfer means for reproducing data from the recording and reproducing means in accordance with the playlist selected by the selecting means based upon the instruction from the instructing means and which transfers the playlist and the data through the network to the data transmission section.

According to this data transmission apparatus, the playlists indicating the lists of the data, which were created by the data creating section and recorded on the recording and reproducing means, to be transmitted are created by the playlist creating means, and a playlist transferred to the data transmission section is selected from the created playlists by the selecting means. Then, in the data creating section, when the start of the transfer of the playlist is instructed by the instructing means, the transfer means reproduces data from the recording and reproducing means in accordance with the playlist selected by the selecting means, and the playlist thus selected and the data are transferred through the network to the data transmission section.

As described above, according to this data transmission apparatus, based upon the playlist transfer start instruction issued from the instructing means within the data creating section, the playlists that should be transferred to the data transmission section and the data on the playlists are transferred through the network from the data creating section to the data transmission section.

As a result, without carrying out a time-consuming and troublesome work in which data should be re-recorded on a portable recording medium in the sequential order of the data to be transmitted and in which such recording medium should be carried from the data creating section to the data transmission section, the data created by the data creating section can be distributed to the data transmission section.

Accordingly, if this data transmission apparatus is applied to the CATV service (i.e., if the master station is provided with the data creating section and both of the master station and the slave stations serving as the slave stations are connected via the network), for example, then without carrying out a time-consuming and troublesome work in which the materials are re-recorded on the video tape in the sequential order of the materials to be transmitted and in which such video tape is carried from the master station to the slave stations unlike the prior art, the materials created by the master station can be distributed to the slave stations.

If this data transmission apparatus is applied to the transmission service using the display installed in the public place (i.e., the editing room is provided with this data creating section and both of the editing room and the places in which the displays are installed serving as the data transmission sections are connected by the network), for example, then without carrying out a time-consuming and troublesome work in which the materials are re-recorded on the video tape in the sequential order of the materials to be transmitted and in which such video tape is carried from the editing room to the places in which the displays are installed unlike the prior art, the materials created by the editing room can be distributed to the places in which the displays are installed.

Next, a data transmission method according to the present invention in which a data creating section for creating transmitted data and data transmission sections for transmitting data are connected by a network comprises a first step of recording created data in the data creating section, a second step of creating playlists for indicating the transmission schedule of the data which are recorded at the first step in the data creating section, a third step of selecting a playlist transferred to the data transmission sections from the playlists created at the second step and a fourth step of reproducing the data recorded at the first step in accordance with the playlists selected at the third step and which transfers those playlists and data through the network to the data transmission sections.

According to this data transmission method, the playlists indicating the transmission schedule of the created and recorded data are created by the data creating section, and a playlist to be transferred to the data transmission section is selected from the created playlists. Then, in the data creating section, the recorded data are recreated in accordance with the selected playlist, and those playlist and data are transferred through the network to the data transmission section.

As described above, according to this data transmission method, the playlists that should be transferred to the data transmission section and the data stated in the playlist are transferred through the network from the data creating section to the data transmission section.

As a result, without carrying out a time-consuming and troublesome work in which data should be re-recorded on a portable medium in the sequential order of the data to be transmitted and in which such medium should be carried from the data creating section to the data transmission section, the data created by the data creating section can be distributed to the data transmission section.

Accordingly, if this data transmission method is applied to the CATV service (i.e., if a master station serves as the data creating section, slave stations serves as the data transmission sections, both of them are connected via the network and the master station executes the first step to-the fourth step), for example, then without carrying out a time-consuming and troublesome work in which the materials are re-recorded on the video tape in the sequential order of the materials to be transmitted and in which such video tape is carried from the master station to the slave stations unlike the prior art, the materials created by the master station can be distributed to the slave stations.

Furthermore, if this data transmission apparatus is applied to the transmission service using the display installed at the public place (i.e., the editing room is provided with this data creating section, both of the editing room and the places in which the displays are installed serving as the data transmission sections are connected via the network and the editing room executes the first step to the fourth step), for example, then without carrying out a time-consuming and troublesome work in which the materials are re-recorded on the video tape in the sequential order of the materials to be transmitted and in which such video tape is carried from the editing room to the places in which the displays are installed unlike the prior art, the materials created by the editing room can be distributed to the places in which the displays are installed.

Next, there is provided a data transmission apparatus according to the present invention in which a data creating section for creating transmitted data and data transmission sections for transmitting data are connected via a network. The playlist creating section includes an attribute imparting means for imparting an attribute to instruct a transmission standby to a playlist and a transfer means for transferring a created playlist and information on this attribute imparted to the playlist through the network to the data transmission section. The data transmission section includes a time setting means for setting a time at which the transmission standby is effected and a transmission standby means for judging based upon the information on this attribute whether or not this attribute is imparted to the playlist transferred from the playlist creating section at the time set by this time setting means and which executes the transmission standby based upon the playlist to which this attribute is imparted.

According to this data transmission apparatus, in the playlist creating section, the attribute for instructing the transmission standby is imparted to the playlist by the attribute imparting means. Then, in the playlist creating section, the created playlist and the information on this attribute imparted to the playlist are transferred through the network to the data transmission section by the transfer means.

Then, in the data transmission section, it is determined by the transmission standby means based upon the information on this attribute whether or not this attribute is imparted to the playlist transferred from the playlist creating section at the time set by the time setting means and the data transmission section executes the transmission standby based upon the playlist to which this attribute is imparted.

As described above, according to this data transmission apparatus, the data transmission section side can automatically execute the transmission standby based on the playlist transferred from the playlist creating section at the time set by the time setting means without man's work.

Accordingly, if this data transmission apparatus is applied to the CATV service (i.e., if the master station is provided with the playlist creating section, the slave station is provided with the data transmission section and both of them are connected via the network), for example, then the slave station side becomes able to automatically execute the transmission standby based upon the playlist distributed from the master station without an operation of a staff member in the broadcasting station unlike the prior art.

Further, if this data transmission apparatus is applied to the transmission service using the display installed in the public place (i.e., if the editing room is provided with this playlist creating section, the data transmission section is located in the place wherein the display is installed and both of them are connected via the network), for example, then on the side of the place in which the display is installed, it becomes possible to automatically carry out the transmission standby based upon the playlist distributed from the editing room without an operation of a person in charge unlike the prior art.

Next, in a transmission standby method in a data transmission apparatus in which a playlist creating section for creating a playlist for indicating a transmission schedule of data and a data transmission section for transmitting data based upon the playlist are connected together via the network, the data transmission section including a time setting means for setting a time at which a transmission standby is executed and a transmission standby means for judging whether or not an attribute for instructing the transmission standby is imparted to a playlist at a time set by this time setting means and which executes the transmission standby based upon the playlist to which this attribute is imparted, a transmission standby method according to the present invention comprises a first step for imparting this attribute to the playlist in the playlist creating section, a second step of transferring the playlist created by the playlist creating section and information on the attribute imparted to the playlist at the first step through the network to the transmission standby means of the data transmission section and a third step of setting a time at which a transmission standby is executed by the time setting means.

According to this transmission standby method, in the playlist creating section, the attribute for instructing the transmission standby is imparted to the playlist, and the created playlist and the information on this attribute imparted to the playlist are transferred through the network to the transmission standby means of the data transmission section. On the other hand, in the data transmission section, a time at which a transmission standby is executed is set by the time setting means.

As a consequence, in the data transmission section, the transmission standby means judges based upon the information on this attribute whether or not this attribute is imparted to the playlist transferred from the playlist creating section at the time set by the time setting means, and the transmission standby means executes the transmission standby based upon the playlist to which the attribute is imparted.

As described above, according to this transmission standby method, the data transmission section side can automatically carry out the transmission standby based on the playlist transferred from the playlist creating section at the time set by the time setting means without man's work.

Accordingly, if this transmission standby method is applied to the CATV service (i.e., if the master station serves as the playlist creating section, the slave station serves as the data transmission section, both of them are connected together via the network and the master station and the slave station execute the processings of the first, second and third steps, respectively), for example, then the slave station side becomes able to automatically execute the transmission standby based on the playlist distributed from the master station without an operation of a staff member in the broadcasting station unlike the prior art.

Further, if this transmission standby method is applied to the transmission service using the display installed at the public place (i.e., if the editing room serves as the playlist creating section, the place in which the display is installed serves as the data transmission section, both of them are connected together by the network and the editing room and the place in which the display is installed execute the processings of the first, second and third steps, respectively), for example, then the side of the place in which the display is installed becomes able to automatically execute the transmission standby based on the playlist distributed from the editing room without an operation of a staff member in the broadcasting station unlike the prior art.

Next, a transmission standby apparatus according to the present invention comprises a playlist creating means for creating a playlist for indicating a transmission schedule of data, an attribute imparting means for giving an attribute for instructing a transmission standby to the playlist, a time setting means for setting a time at which a transmission standby is executed and a transmission standby means for judging whether or not this attribute is imparted to the playlist created by the playlist creating means at the time set by the time setting means and which executes a transmission standby based on the playlist to which this attribute is imparted.

In this transmission standby apparatus, the attribute for instructing the transmission standby is imparted to the playlist by the attribute imparting means. Then, the transmission standby means judges whether or not this attribute is imparted to the playlist created by the playlist creating means at the time set by the time setting means and executes the transmission standby based on the playlist to which this attribute is imparted.

As described above, according to this transmission standby apparatus, the transmission standby based upon the created playlist can automatically be executed at the time set by the time setting means without man's work.

Accordingly, if this transmission standby apparatus is applied to the transmission system of the broadcasting station which transmits the created material from its station, for example, then it becomes possible to automatically execute the transmission standby of the material based upon the playlist without an operation of a staff member in the broadcasting station unlike the prior art.

Next, a transmission start apparatus according to the present invention comprises a playlist creating means for creating a playlist indicating a transmission schedule of data, an attribute imparting means for imparting an attribute for instructing a transmission standby to the playlist, a transmission trigger setting means for setting a transmission trigger with respect to data added to the playlist, a time setting means for setting a time at which a transmission standby is carried out, a transmission standby means for judging whether or not this attribute is imparted to the playlist created by the playlist creating means at the time set by the time setting means and which executes a transmission standby based upon the playlist to which this attribute is imparted and a transmission start means for judging the arrival of the transmission trigger set by the transmission trigger setting means with respect to the data on which the transmission standby is effected by the transmission standby means and which starts the transmission of such data.

In this transmission start apparatus, the attribute for instructing the transmission standby is imparted to the playlist by the attribute imparting means. Furthermore, the transmission trigger with respect to the data added to the playlist is set by the transmission trigger setting means.

Then, the transmission standby means judges whether or not this attribute is imparted to the playlist created by the playlist creating means at the time set by the time setting means and executes the transmission standby based upon the playlist to which this attribute is imparted. Then, the transmission start means judges the arrival of the transmission trigger set by the transmission trigger setting means with respect to the data on which the transmission standby is effected by the transmission standby means and starts the transmission of that data.

As described above, according to this transmission start apparatus, the transmission standby based upon the created playlist can automatically be executed at the time set by the time setting means without man's work. Then, each time the transmission trigger with respect to the data on which the transmission standby is effected arrives, the transmission of that data can be started.

Accordingly, if this transmission start apparatus is applied to the transmission system of the broadcasting station for transmitting the created material from its own station, for example, then the transmission standby of the material based on the playlist can automatically be executed without an operation of a staff member in the broadcasting station unlike the prior art. Furthermore, each time the transmission trigger with respect to the data on which the transmission standby is effected arrives, it becomes possible to automatically start the transmission of that data.

Next, in a transmission standby method in a data transmission system comprising a playlist creating means for creating a playlist indicative of a transmission schedule of data, a time setting means for setting a time at which a transmission standby is executed, a transmission standby means for judging whether or not an attribute for instructing a transmission standby is imparted to the playlist created by the playlist creating means at the time set by the time setting means and which executes a transmission standby based upon the playlist to which this attribute is imparted and a transmission means for transmitting data, a transmission standby method according to the present invention comprises a first step of imparting this attribute to the playlist created by the playlist creating means and a second step of setting a time at which a transmission standby is executed by the time setting means.

According to this transmission standby method, the attribute for instructing a transmission standby is imparted to the playlist. Furthermore, the time setting means sets a time at which a transmission standby is executed.

As a consequence, the transmission standby means judges based upon the information on this attribute whether or not this attribute is imparted to the playlist transferred from the playlist creating section at the time set by the time setting means and executes the transmission standby based upon the playlist to which the attribute is imparted.

As described above, according to this transmission standby method, the transmission standby based upon the created playlist can automatically be executed at the time set by the time setting means without man's work.

Accordingly, if this transmission standby method is applied to the transmission system of the broadcasting station which transmits the created materials from its own station, then it becomes possible to automatically execute the transmission standby of the material based upon the playlist without an operation of a staff member in the broadcasting station unlike the prior art.

Next, in a transmission start method in a data transmission system including a playlist creating means for creating playlists indicative of a transmission schedule of data, a time setting means for setting a time at which a transmission standby is executed and a transmission standby means for judging whether or not an attribute for instructing a transmission standby is imparted to the playlist created by the playlist creating means at the time set by the time setting means and which executes a transmission standby based upon the playlist to which this attribute is imparted and a transmission means for transmitting data, a transmission start method according to the present invention comprises a first step of imparting this attribute to the playlist, a second step of setting a transmission trigger with respect to data added to the playlist, a third step of setting a time at which a transmission standby is executed by the time setting means and a fourth step of judging based upon information on a transmission trigger whether or not a transmission trigger with respect to data on which a transmission standby is effected by the transmission standby means has arrived and which starts the transmission of that data.

According to this transmission start method, the attribute for instructing the transmission standby is imparted to the playlist. Furthermore, there is set the transmission trigger with respect to data added to the playlist. Moreover, the time at which the transmission standby is executed is set by the time setting means.

As a result, the transmission standby means judges based upon the information of this attribute whether or not this attribute is imparted to the playlist transferred from the playlist creating section at the time set by the time setting means and executes the transmission standby based upon the playlist to which this attribute is imparted. Then, with respect to the data on which the transmission standby is effected by the transmission standby means, the transmission start means judges whether or not the transmission trigger set by the transmission trigger setting means arrived and starts the transmission of that data.

As described above, according to this transmission start method, the transmission standby based upon the created playlist can automatically be executed at the time set by the time setting means without man's work. Then, each time the transmission trigger with respect to the data on which the transmission standby is effected arrived, the transmission of that data is started.

Accordingly, if this transmission start method is applied to the transmission system of the broadcasting station which transmits the created material from its own station, for example, then the transmission standby of the material based upon the playlist can automatically be carried out without an operation of a staff member in the broadcasting station unlike the prior art. Furthermore, each time the transmission trigger with respect to the data on which the transmission standby is effected arrives, the transmission of that data can be started automatically.

### BRIEF DESCRIPTION OF DRAWINGS

FIG. 1 is a diagram showing an example of an overall configuration of a network CATV system to which the present invention is applied.

FIG. 2 is a diagram showing an example of an configuration of a video server 12 of FIG. 1.

FIG. 3 is a diagram showing a main menu screen displayed on a personal computer 11 of FIG. 1.

FIG. 4 is a diagram showing a screen which is used to make a clip.

FIG. 5 is a diagram showing a screen which is used to make a clip.

FIG. 6 is a diagram showing a screen which is used to make a clip.

FIG. 7 is a diagram showing a screen which is used to manage a clip.

FIG. 8 is a diagram showing a screen which is used to manage a clip.

FIG. 9 is a diagram showing a screen which is used to make a playlist.

FIG. 10 is a diagram showing a screen which is used to make a playlist.

FIG. 11 is a diagram showing a screen which is used to make a playlist.

FIG. 12 is a diagram showing a screen which is used to transfer a playlist.

FIG. 13 is a diagram showing a screen which is used to set a destination to which a playlist is transferred.

FIG. 14 is a diagram showing an outline of communication procedures executed between a master station 1 and a slave station 2 of FIG. 1.

FIG. 15 is a diagram showing a screen which is used to transfer a clip.

FIG. 16 is a diagram showing a screen which is used to effect a transmission standby and to start a transmission.

FIG. 17 is a diagram showing a screen which is used to set a time at which transmission standby is effected automatically.

FIG. 18 is a flowchart showing a processing which is executed by a personal computer 31 of FIG. 1 to effect a transmission standby and to start a transmission.

FIG. 19 is a diagram showing a screen which is used to carry out a transmission standby by a manual operation.

FIG. 20 is a diagram showing part of the transmission system of the master station 1 in the CATV system of FIG. 1.

FIG. 21 is a diagram showing an example of an overall configuration of a network billboard system to which the present invention is applied.

### BEST MODE FOR CARRYING OUT THE INVENTION

An example in which the present invention is applied to a CATV service will be described below.

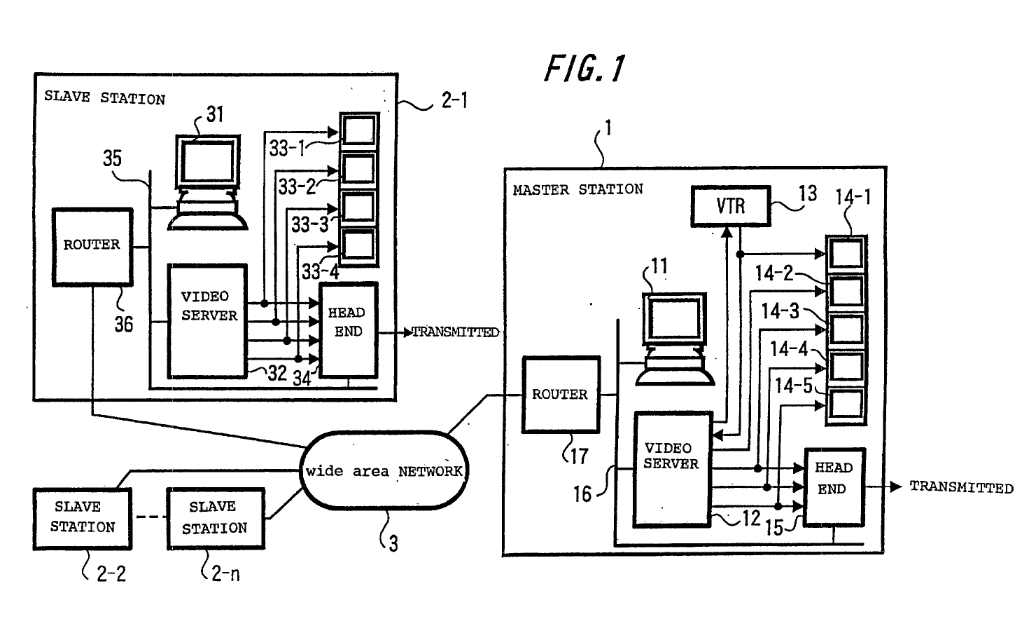

FIG. 1 shows an example of an overall configuration of a system in which the present invention is applied to a CATV service (network CATV system).

In this network CATV system, a CATV station (master station) 1 for creating materials and a plurality of CATV stations (slave stations) 2 (2-1 to 2-n) for transmitting the materials thus created by the master station 1 are connected via a wide area network 3 of an ATM (asynchronous transfer mode) communication system. The master station 1 and the respective slave stations 2 are established in the areas distant from each other in Japan or overseas.

The master station 1 comprises a personal computer 11, a video server 12, a VTR 13, five monitors 14 (14-1 to 14-5) and a head end 15. The personal computer 11, the video server 12 and the head end 15 are connected to Ethernet 16 within the master station 1. This Ethernet 16 is connected to the wide area network 3 through a router 17.

The personal computer 11 has installed therein application software to control the video server 12 so that materials and playlists, which will be described later on, may be created, attributes may be imparted to the playlists, a transmission trigger may be set, the playlists and the materials may be transferred and a transmission standby and a transmission may be started.

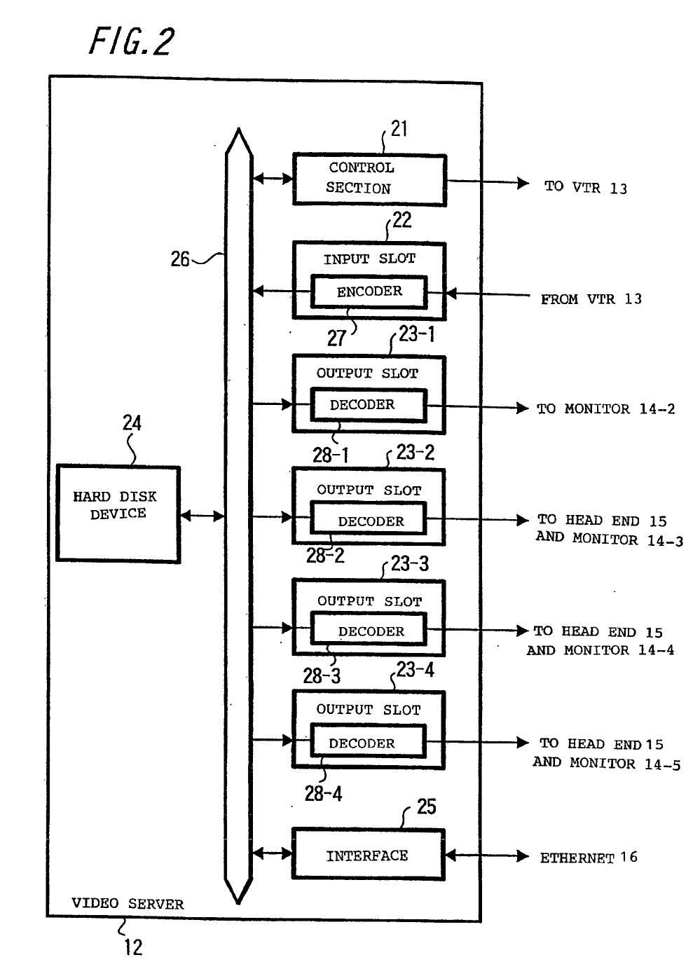

The video server 12 has a configuration shown in FIG. 2, for example. A control section 21, a single input slot 22, four output slots 23 (23-1 to 23-4), a hard disk device 24 and an interface 25 for connecting the video server to the Ethernet 16 (FIG. 1) are connected together via a bus 26.

A control signal is supplied from the personal computer 11 (FIG. 1) to the control section 21. Based upon this control signal, the control section 21 controls the whole of the video server 12 and the operations of the VTR 13 (FIG. 1).

The input slot 22 includes an encoder 27 which encodes compresses) AV data (video and/or audio data) in accordance with an encoding system, such as an MPEG2. The respective output slots 23-1 to 23-4 include decoders 28-1 to 28-4 which decode (expand) video data in accordance with the same encoding system as that of the encoder 22a. The respective slots 22, 23 operate independently of each other, carry out input or output of video data and transfer video data between them and the hard disk device 24 via the bus 26 within their time slots.

The video server 12 is able to load five in total of input slots and output slots. Accordingly, the video server is able to load the output slots instead of the input slots 22 and is also able to load the input slots replacing a part of the output slots 23.

The hard disk device 24 may be configured by using a RAID (Redundant Arrays of Inexpensive Disks) technology. According to the RAID-3, for example, AV data is divided into block data of a constant length and these block data of AV data are recorded on a plurality of hard disk drives. Concurrently therewith, parity data of their block data are generated and are written in another hard disk drive. Then, upon reproduction, block data and parity data are recreated from these hard disk drives. When block data is not recreated from any one of the hard disk drives, block data which is not recreated is restored by parity data and these block data are restored to the original AV data.

The VTR 13 in FIG. 1 has recorded thereon AV data which is source data to create a material (e.g., live AV data shot by a television camera on the news-collecting ground). AV data recreated from the VTR 13 is inputted into the input slot 22 of the video server 12 and is also displayed on the monitor 14-1.

The material outputted from the output slot 23-1 of the video server 12 is displayed on only the monitor 14-2 and is not supplied to the head end 15. On the other hand, the materials outputted from the output slots 23-2 to 23-4 of the video server 12 are respectively displayed on the monitors 14-3 to 14-5 and are also supplied to the head end 15. The head end 15 transmits the materials through a transmission line (cable) to a CATV terminal (not shown) within the service area of the master station 1.

A material supplied to the master station 1 from an external material supply source (not shown) through the wide area network 3 is directly supplied to the head end 15 through the Ethernet 16 and a router 17 is thereby transmitted from the head end 15.

On the other hand, each slave station 2 includes a personal computer 31, a video server 32, four monitors 33-1 to 33-5 and a head end 34 as typically shown by a slave station 2-1. The personal computer 31, the video server 32 and the head end 34 are connected to Ethernet 35 within the slave station 2. This Ethernet 35 is connected to the wide area network 3 through a router 36.

The same application software as that of the personal computer 11 of the master station 1 is installed in the personal computer 31.

The video server 32 is of the same type as the video server 12 of the master station 1 and therefore, is loaded with one input slot and four output slots similarly to the video serve 12. Materials outputted from the respective output slots of the video server 32 are respectively displayed on the monitors 33-1 to 33-4 and are also supplied to the head end 34. The head end 34 transmits a material to a CATV terminal within the service area of the slave station 2 through a transmission line (cable).

The material supplied to the slave station 2 from an external material supply source (not shown) other than the master station 1 through the wide area network 3 is directly supplied to the head end 34 via the router 36 and the Ethernet 35 and is thereby transmitted from the head end 34.

Next, the manner in which the master station 1 creates materials and playlists, the master station 1 imparts attributes to the playlists, the master station 1 sets a transmission trigger and the master station 1 transfers materials and playlists to each slave station 2 will be described. A material which is made by encoding AV data will hereinafter be referred to as a “clip”.

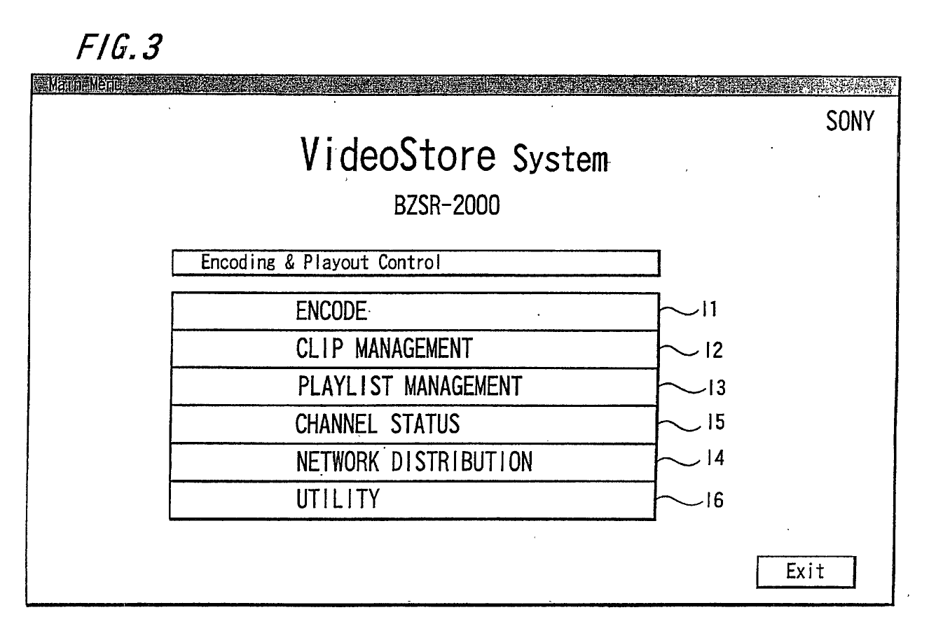

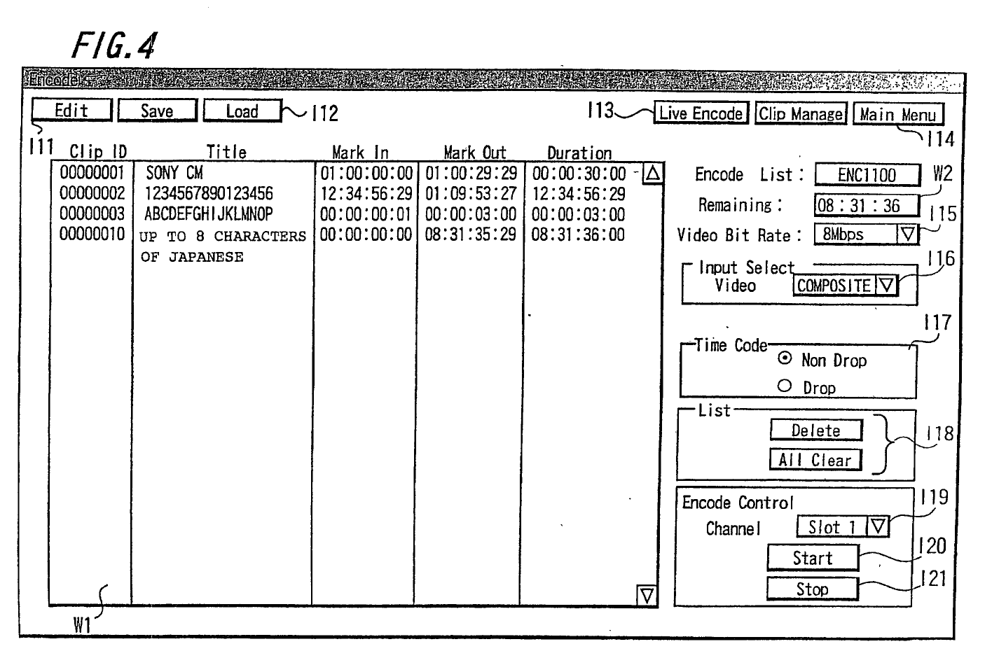

FIG. 3 shows a main menu screen displayed on the display of the personal computer 11 of the master station 1. On this main menu screen, there exists an icon (icon displayed as “ENCODE”) I1 which allows a user to select creation of a new clip (material). When a user clicks this icon I1, there is displayed a clip creating screen shown in FIG. 4.

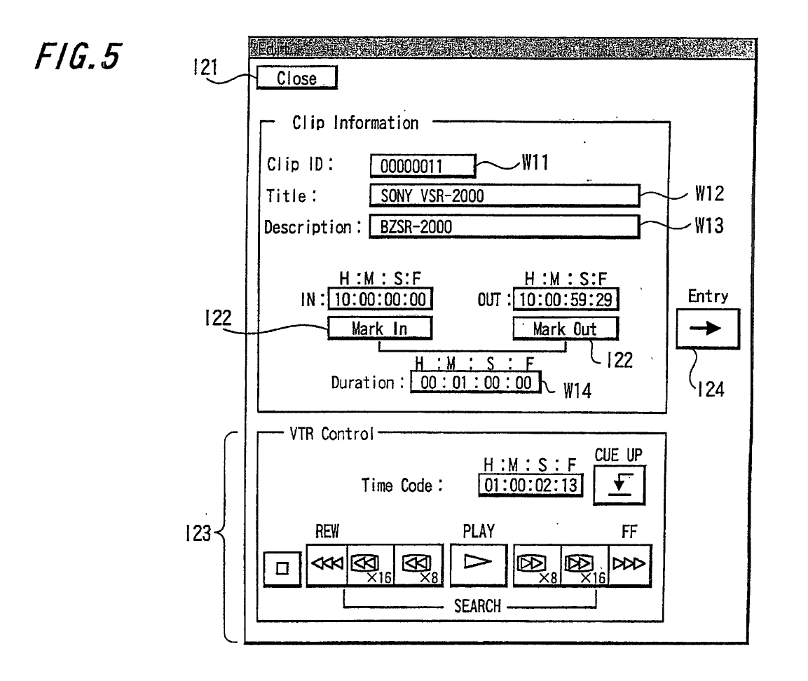

When a user clicks an icon I11 displayed on the upper end of the screen of FIG. 4, there is displayed a screen shown in FIG. 5. On the upper side of this screen, there exist a box W11 which enables a user to enter a target of operation clip identifying ID, a box W12 which enables a user to enter a title of this clip and a box W13 which enables a user to enter words and phrases to describe the contents of this clip.

On the lower side of this screen, there exist a plurality of icons I23 which can drive the VTR 13 to reproduce AV data.

On the center of the screen of FIG. 5, there exist a plurality of icons I22 which are used to designate edit points (IN-point and OUT-point) of recreated AV data in the form of time code values and a box W14 which is used to display duration from the IN-point to the OUT-point designated by the icon I22.

On the right-hand end of the screen of FIG. 5, there exists an icon I24 which is used to register on the encode list the contents entered into the boxes W11 to W13 and the edit points (i.e., information on the target-of-creation clip) designated by the icon I22.

After information on the target-of-creation clip is registered on the encode list, when the user clicks the icon I21 displayed on the upper end of the screen of FIG. 5, the screen returns to the screen of FIG. 4. When the user clicks the icon I12 displayed on the upper end of the screen of FIG. 4, target-of-creation clips that had been so far registered on the encode list are displayed on the box WI of this screen in the form of a list.

On the right-hand end of the screen of FIG. 4, there exist a box W2 in which an amount of a remaining storage capacity of the hard disk device 24 of the video server 12 is displayed, an icon I15 which is used to set a bit rate (compression ratio) of encoding by a pull-down system, an icon I16 which is used to set a type (composite signal or component signal) of a video signal inputted to the video server 12 by a pull-down system, an icon I17 which is used to select whether or not a delay of a time code value relative to a real time should be corrected by a drop frame when an NTSC video signal is inputted, a plurality of icons I18 which are used to erase a part of or whole of target-of-creation clips displayed on the left-hand side of the screen in the form of a list, an icon I19 which is used to select a certain input slot of the video server 12 to enter and encode AV data (only one input slot 22 can be selected in the configuration of FIG. 2), an icon I20 which is used to start creation of clips with respect to the target-of-creation clips displayed on the left-hand side of the screen in the form of a list and an icon I21 which is used to stop the creation of a clip.

When a user displays the screen of FIG. 4 and operates the apparatus, with respect to the respective target-of-creation clips displayed on the box W1 in the form of a list, AV data from the IN-point to the OUT-point is reproduced from the VTR 13 and displayed on the monitor 14-1 and is also inputted into the input slot 22 of the video server 12 and encoded by the encoder 22a (i.e., clips are created). Then, that clip is transferred from the input slot 22 through the bus 26 to the hard disk device 24 and thereby stored in the hard disk device 24.

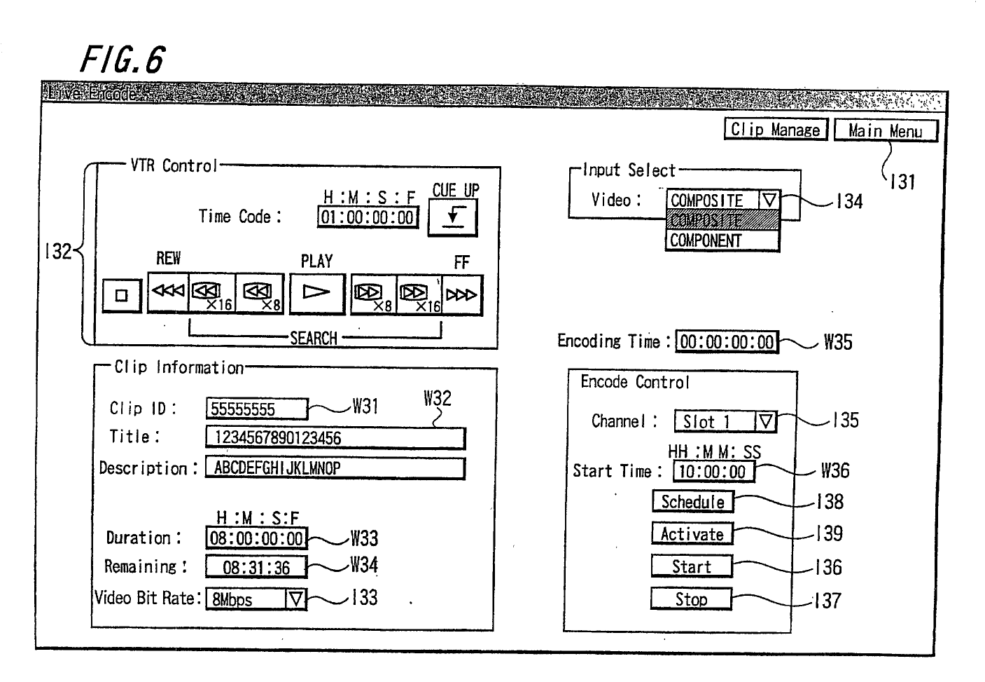

When the user clicks the icon I13 displayed on the upper end of the screen of FIG. 4, there is displayed a screen which is used to create a clip on the spot while the user is searching the edit points by operating the VTR 13 as shown in FIG. 6 unlike the operation in which a clip is created after information on a target-of-creation clip is registered in advance.

On the upper left side of the screen of FIG. 6, there exist a plurality of icons I32 which are used to drive the VTR 13 to reproduce AV data. On the lower left side of this screen, there exist a box W31 which is used to input target-of-creation clip identifying ID, a box W32 which is used to input a title of this clip, a box W33 which is used to input words and phrases for describing the contents of this clip, a box W34 which is used to display duration of the clip, a box W35 which is used to display an amount of a remaining storage capacity of the hard disk device 24 of the video server 12 and an icon I33 which is used to set a bit rate of the encoder 22a of the video server 12 by a pull-down system.

On the upper right side of the screen of FIG. 6, there exist an icon I34 which is used to set a type of a video signal inputted to the video server 12 by a pull-down system and a box W35 which is used to display an encoding time as a guide.

On the lower right side of the screen of FIG. 6, there exist an icon I35 which is used to select a certain input slot of the video server 12 to input and encode the AV data by a pull-down system, an icon I36 which is used to start creating of a clip, an icon I37 which is used to stop creating of a clip, a box W36 which is used to input a constant time required when the apparatus starts automatically creating a clip at the constant time, an icon I38 which is used to automatically start creating of a clip at the time inputted to the box W36 and an icon I39 which is used to start creating of a clip each time a signal (GPI signal) for instructing the start of creating of a clip is supplied from a host computer to the personal computer 11.

When the screen of FIG. 6 is displayed and the user operates this apparatus, the VTR 13 is driven while the edit points are being searched so that the live AV data is inputted to the input slot 22 of the video server 12 on the spot and encoded by the encoder 22a (i.e., clip is created). Then, the clip thus created is transferred from the input slot 22 through the bus 26 to the hard disk device 24 and thereby stored in the hard disk device 24.

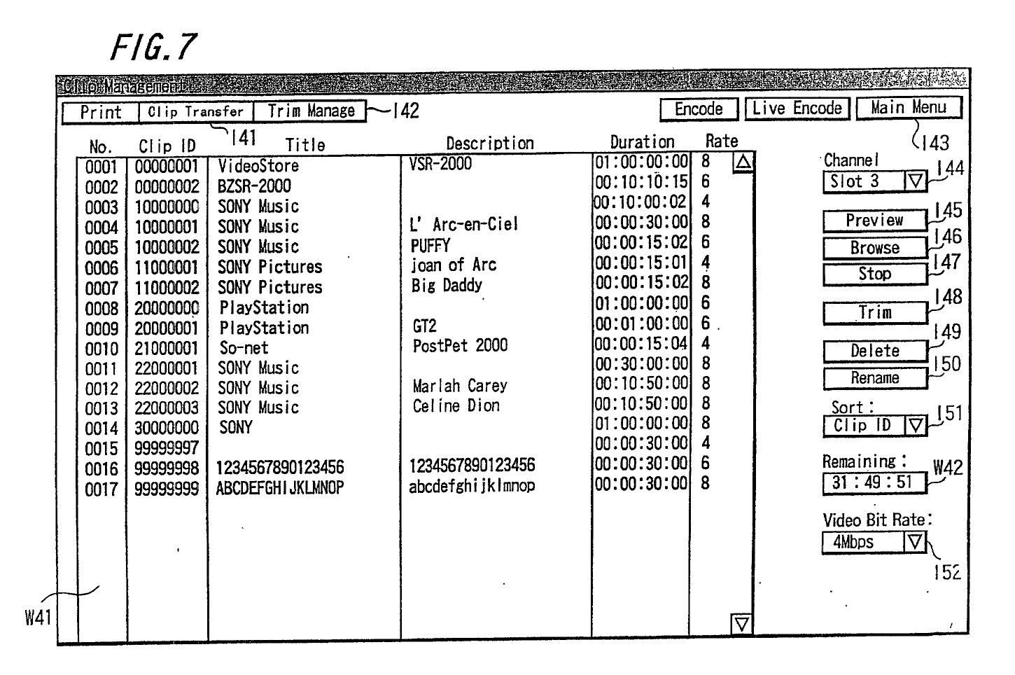

When the user clicks the icon I31 displayed on the upper end of the screen of FIG. 6 or clicks the icon I14 displayed on the upper end of the screen of FIG. 4, the screen is returned to the main menu screen of FIG. 3. On this main menu screen, there exists an icon (icon displayed as “CLIP MANAGEMENT”) I2 which enables a user to select the management of the clips that were already created. When the user clicks this icon I2, there is displayed a clip management screen shown in FIG. 7.

On the screen of FIG. 7, there exists a box W41 which is used to display created clips in the form of a list and which enables a user to select arbitrary one or a plurality of clips by a mouse.

On the right-hand end of the screen of FIG. 7, there exist an icon I44 which is used to select a certain output slot of the video server 12 to output a clip selected at the box W41 and which selects the confirmation of the selected clip by a monitor in accordance with a pull-down system (in the configuration of FIG. 2, of the output slots 23-1 to 23-4 only the output slot 23-1 from which outputted material is not supplied to the head end 15 is capable of being selected), an icon I45 which is used to reproduce/output the above clip from the video server 12, an icon I46 which is used to reproduce/output only the first fixed seconds (e.g., fixed seconds) of the clip, an icon I47 which is used to stop the reproduction/output of the clip, an icon I48 which is used to create trimming information, which will be described later on, with respect to the clip selected at the box W41, an icon I49 which is used to delete the clip selected at the box W41, an icon I50 which is used to rename the title of the clip selected at the box W41, an icon I51 which is used to rearrange the clips displayed at the box W41 in the sequential order of IDs and in the alphabetical order of the titles or the like, a box W42 in which an amount of a remaining storage capacity of the hard disk device 24 of the video server 12 and an icon I52 which is used to set a bit rate by a pull-down system.

When the user clicks the icons I45 and I46, the clip selected at the box W41 is reproduced from the hard disk device 24 of the video server 12 and transferred through the bus 26 to the output slot 231. Then, the above clip is decoded by the decoder 28-1, outputted from the output slot 23-1 and then displayed on the monitor 14-2. Accordingly, the user can visually confirm the contents of the clip that has already been created through the monitor 14-2. When it is determined by the user based upon confirmed results that the clip is unnecessary, the user can delete such unnecessary clip by the icon I47.

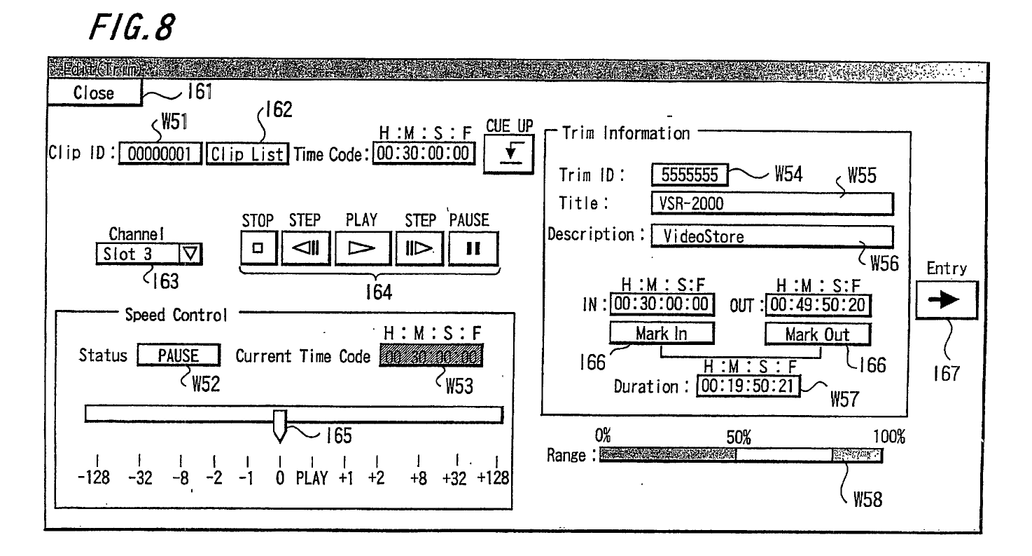

On the upper end of the screen of FIG. 7, there exists an icon I42 which is used to create trim information which is edit information for defining IN-point and OUT-point obtained after the created clip has been edited (i.e., information used to trim part of the created clip and to transmit the trimmed portion). When the user clicks the icon I42 or the aforementioned icon I48 displayed at the right-hand end of the screen, there is displayed a trim information creating screen shown in FIG. 8.

On the upper left-hand side of the screen of FIG. 8, there exist a box W51 in which an ID of a target-of-creation clip for trim information is displayed, an icon I62 which is used to open a window to list up created clips in order to select a clip when a user clicks the icon I41 of the screen of FIG. 7 to display the screen of FIG. 8 (i.e., when the target-of-creation clip for trim information is not yet selected), an icon I63 which is used to select a certain output slot of the video server 12 to output the target-of-creation clip for the trim information and to visually confirm the same on the monitor by a pull-down system and a plurality of icons I64 which are used to reproduce/output the target-of-creation clip for the trim information from the video server 12.

On the lower left-hand side of the screen of FIG. 8, there exist an icon I65 which is used to adjust a speed at which a clip is recreated, a box W52 in which a current reproducing state is displayed and a box W53 in which a current time code value is displayed.

On the right-hand side of the screen of FIG. 8, there exist a box W54 which is used to input a target-of-creation identifying ID for trim information, a box W55 which is used to input a title of this trim information, a box W56 which is used to input words and phrases for describing the contents of this trim information, a plurality of icons I66 which are used to designate with time code values edit points (IN-point and OUT-point) obtained after editing, a box W57 in which duration from the edited IN-point to the edited OUT-point designated by the icon I66 is displayed and a box W58 in which a range of the edited IN-point to the edited OUT-point with respect to the original range from the IN-point to the OUT-point is displayed.

On the right-hand end of the screen of FIG. 8, there exists an icon I67 which is used to have the personal computer 11 store the contents inputted to the boxes W54 to W56 and the edited edit points designated by the icon I6 (i.e., created trim information).

In case there is a need to edit and transfer a clip after the content of the clip is visually confirmed on the monitor 14-2 by the icons I45 and I46 of FIG. 7, by displaying the screen of FIG. 8 and operating the apparatus, trim information is created and stored in the personal computer 11.

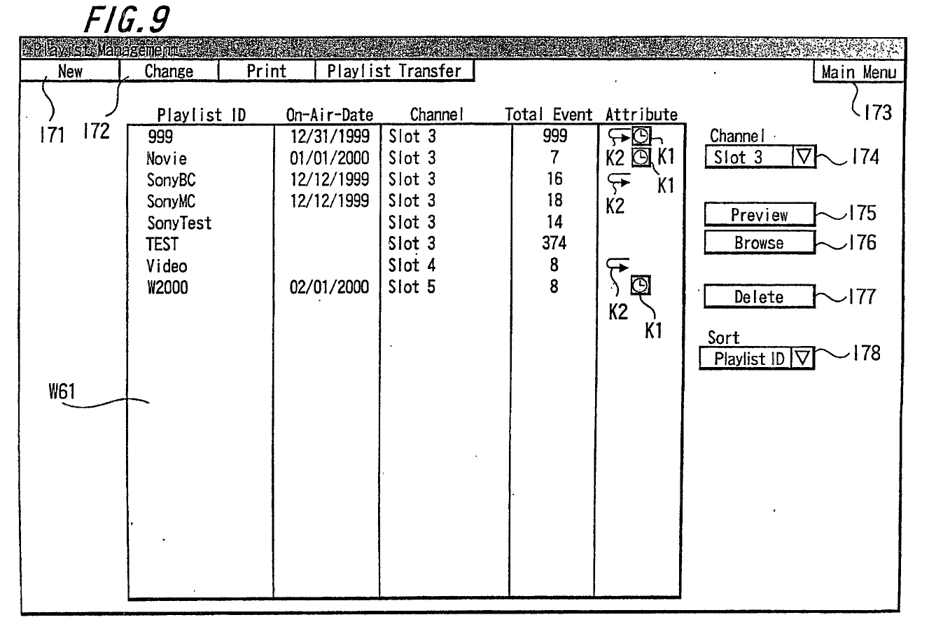

When the user clicks the icon I61 displayed at the upper end of the screen of FIG. 8, this screen returns to the screen of FIG. 7. When the user clicks the icon I43 displayed at the upper end of the screen of FIG. 7, this screen returns to the main menu screen of FIG. 3. On this main menu screen, there exists an icon (icon displayed as “PLAYLIST MANAGEMENT”) I3 which urges the user to select a playlist showing a transmission schedule of clips. When the user clicks this icon I3, there is displayed a playlist creating screen shown in FIG. 9.

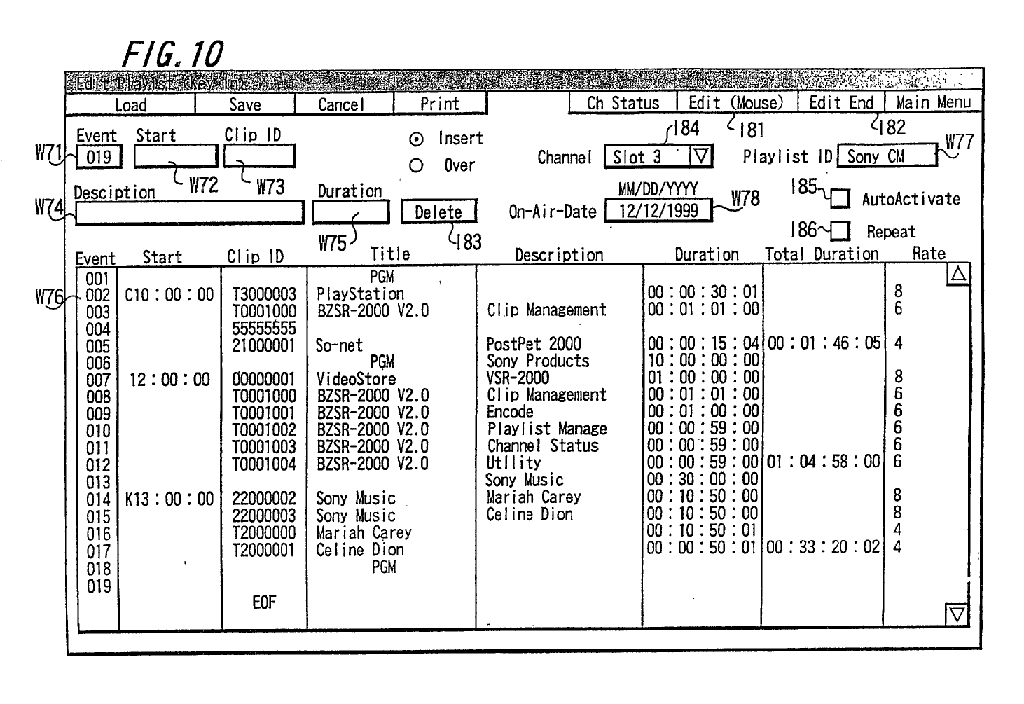

On the upper end of the screen of FIG. 9, there exists an icon I71 which enables the user to select creating of a new playlist. When the user clicks this icon I71, there is displayed a screen shown in FIG. 10.

On the upper left-hand side of the screen of FIG. 10, there exist a box W71 which is used by the user to enter by the keyboard the transmission order (event number) of the desired clips which should be added to the playlist within the playlist, a box W72 which is used by the user to enter by the keyboard a time at which the transmission of the clip is to be started and a box W73 which is used by the user to enter by the keyboard an ID of that clip (ID entered on the clip creating screen of FIG. 5 or 6).

The box W72 serves also as a box for enabling the user to set a transmission trigger of a clip which may be added to the playlist. As the contents of this transmission trigger, there can be set three contents of a fixed time, an operation of the personal computer 31 of the slave station 2 and a transmission instruction signal (GPI signal) issued from a high-order device to the personal computer 31.

When a user wants to set a fixed time as a transmission trigger, the user inputs a desired fixed time to the box W72 as a time at which the transmission of the clip is to be started and also inputs a character “c” (which means “clock”) to the left-hand side of the inputted fixed time.

When on the other hand the user wants to set the operation of the personal computer 31 as the transmission trigger, the user inputs a character “K”, (which means “key”) to the left-hand side of the time at which the transmission of the clip is to be started.

When on the other hand the user wants to set the GPI signal as the transmission trigger, the user inputs to the box W72 only the time at which the transmission of the clip is to be started.

On the lower sides of the boxes W71 to W73 of the screen of FIG. 10, there exist a box W74 in which words and phrases for describing the contents of the clip whose ID is inputted to the box W73 are displayed and a box W75 in which duration of that clip (duration displayed on the clip creating screen of FIG. 5 or 6) is displayed.

On the screen of FIG. 10, there exists a box W76 in which transmission start scheduled times, transmission triggers, IDs, titles (titles inputted on the clip creating screen of FIG. 5 or 6) and the like are displayed in the form of a list in sequential order of event numbers (i.e., playlists thus created are displayed) with respect to the clips added to the playlists when the user inputs data to the boxes W71 to W73.

With respect to an event number whose ID is not inputted but instead “.” (dot) is inputted to the box W73, a time frame (PGM) which can be freely used by each slave station 2 is added to the playlist, and the characters of “PGM” are displayed on the title column in the box W76.

Of each group of the clips which do not contain the PGM, input of the transmission start scheduled time and setting of the transmission trigger at the box W72 may be executed to the head clip (clip having the smallest event number) of that group. FIG. 10 depicts the state in which only in the columns of the transmission start scheduled time and transmission trigger of the box W76, characters of “C00:00:00” (10:00 is a transmission trigger), “12:00:00” (the GPI signal is the transmission trigger) and “K13:00:00” (the operation of the personal computer 31 is the transmission trigger) are displayed as the transmission start scheduled time and the transmission trigger with respect to the head clip in such group.

On the screen of FIG. 10, there exist an icon I83 which is used to delete the created playlist, an icon I84 which enables the user to select particular output slots of the video servers of the master station 1 and the slave station 2 from which the clips on the playlist displayed at the box W76 should be outputted by a pull-down system (any one of the output slots 23-2 to 23-4 can be selected with respect to the video server 12 of the master station 1 and any one of the four output slots can be selected with respect to the video server 32 of the slave station 2 in the configuration of FIG. 2), a box W77 which is used to input an ID for identifying that playlist and a box W78 which is used to input a date at which the clip on the playlist is to be transmitted.

On the screen of FIG. 10, there exist an icon I85 which is used to impart an attribute for instructing an automatic transmission standby (referred to as an “Auto Activate”) to the created playlist and an icon I86 for imparting an attribute which instructs the operation such that the clip on the playlist may be repeatedly transmitted to the created playlist.

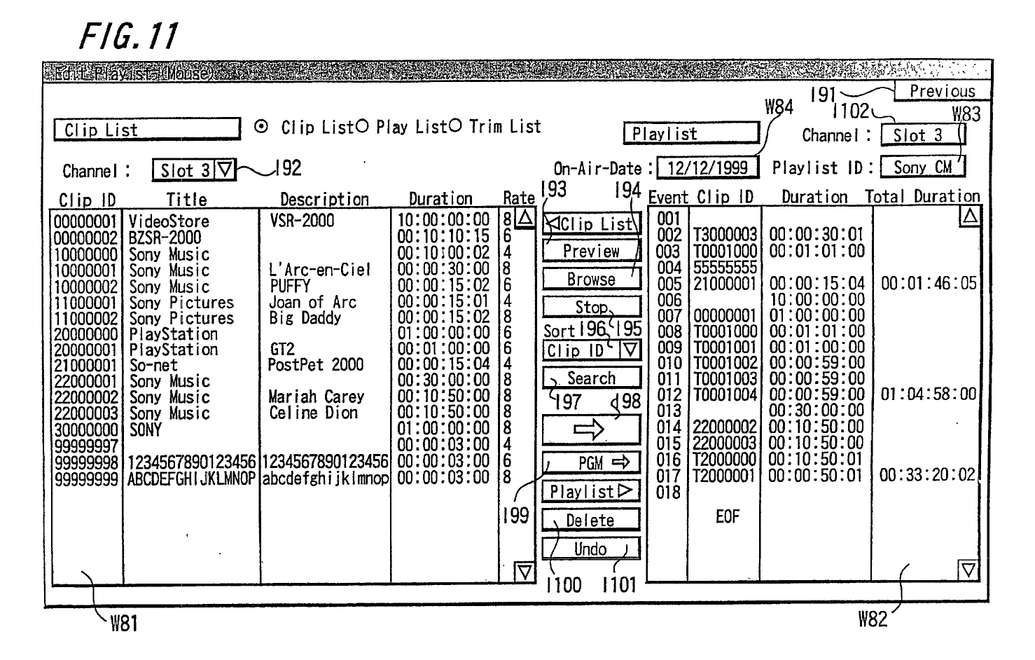

On the upper end of the screen of FIG. 10, there exists an icon I81 which urges the user to select creating of the playlists by operating the mouse. When the user clicks this icon I81, there is displayed a screen shown in FIG. 11.

On the left-hand side of the screen of FIG. 11, there are displayed a list of clips that were already created. There also exist a box W81 which enables the user to select any desired one or a plurality of desired clips by the mouse and an icon I92 which enables the user to select a certain output slot of the video server 12 from which the clip selected at the box W81 should be outputted and which enables the user to visually confirm the selected clip on the monitor by a pull-down system.

On the upper center side of the screen of FIG. 11, there exist an icon I93 which is used by the user to reproduce/output the clip selected at the box W81 from the video server 12, an icon I94 which is used by the user to reproduce/output fixed seconds of the head portion of the selected clip from the video server 12, an icon I95 which is used by the user to stop the reproduction/output of that clip, an icon I96 which is used by the user to rearrange the clips displayed at the box W81 and an icon I97 which is used by the user to search a specific clip from the clips displayed at the box W81.

When the user clicks the icon I93 or I94, the clip which has been selected at the box W81 so as to be added to the playlist is recreated from the hard disk device 24 of the video server 12 and transferred through the bus 26 to the output slot 23-1. Then, that clip is decoded by the decoder 28-1, outputted from the output slot 23-1 and thereby displayed on the monitor 14-2. Accordingly, the user can visually confirm the contents of the desired clip on the playlist on the monitor 14-2.

On the lower center side of the screen of FIG. 11, there exist an icon I98 which is used by the user to add the clips, selected at the box W81, to the playlist in the sequential order of the event numbers, an icon I99 which is used by the user to add a time frame (PGM), which can freely be used by each slave station 2, to the playlist, an icon I100 which is used by the user to delete the clips or the PGM from the playlist and an icon I101 which is used by the user to cancel the immediately-preceding processings done by the icons I98 to I100.

On the right-hand side of the screen of FIG. 11, there exist a box W82 in which the clips and the PGM added to the playlists by the icons I98 and I99 are listed in the sequential order of the event numbers (i.e., the created playlists are displayed), an icon I102 which enables the user to make a selection of from which output slot of the video server of the master station 1 or the slave station 2 the clips on the playlist displayed at the box W82 are outputted and transmitted to the CATV terminal, a box W83 which is used by the user to input the identifying ID of the playlist and a box W84 which is used by the user to input a date at which the clip on the playlist is to be transmitted.

When the screen of FIG. 10 or 11 is displayed and the user operates the apparatus, the playlists can be created, the transmission trigger of the clip to be added to the playlist can be set and the attributes (an attribute for instructing the automatic transmission standby and an attribute for instructing the repetitive transmission of the clip on the playlist) can be imparted to the playlist. After the playlist had been created, the transmission trigger is set and the attribute is imparted to the playlist, when the user clicks a second icon displayed as “SAVE” from the left of the upper end of FIG. 10, information on the created playlist and the transmission trigger and information on the attribute are stored in the personal computer 11.

When the user clicks the icon I91 displayed at the upper end of the screen of FIG. 11, the screen returns to the screen of FIG. 10. When the user clicks the icon I82 displayed at the upper end of the screen of FIG. 10, the current screen returns to the screen of FIG. 9. The playlists already created are listed up on the screen of FIG. 9 and there exists the box W61 in which the user can select arbitrary one or a plurality of arbitrary playlists with the mouse.

On the right end column of this box W61, there are displayed symbols indicating attributes imparted to the playlist by the icons I85 and I86 on the screen of FIG. 10 (a symbol K1 indicative of an attribute which instructs an automatic transmission standby and a symbol K2 indicative of an attribute which instructs a repetition).

On the right-hand end of the screen of FIG. 9, there exists an icon I74 which enables the user to make a selection of from which output slot of the video server 12 each of the clips on the playlist selected at the box W61 is outputted to be visually confirmed on the monitor screen by the pull-down system, an icon I75 which is used to reproduce/output these clips from the video server 12, an icon I76 which is used to reproduce/output fixed seconds of the starting portion of the clip from the video server 12, an icon I77 which is used by the user to delete the playlists selected at the box W61 and an icon I78 which is used to rearrange the playlists displayed at the box W61 in the sequential order of the IDS and the transmission dates.

When the user clicks the icon I75 or I76, the clips on the playlists selected at the box W61 are each reproduced from the hard disk device 24 and transferred through the bus 26 to the output slot 23-1. Then, those clips are decoded by the decoder 28-1, outputted from the output slot 23-1 and thereby displayed on the monitor 14-2. Accordingly, the user can visually confirm, on the monitor 14-2, the contents of the respective clips on the already created playlist. In case the playlist is not needed upon the confirmation, the user can delete the unnecessary playlist by the icon I77.

When the user clicks the icon I72 displayed at the upper end of the screen while the playlist is being selected at the box W61, the screen of FIG. 10 is displayed again and the clips on the playlist are displayed at the box W76 in the form of a list. Further, when the user clicks the icon I81 displayed on the screen of FIG. 10 in this state, the screen of FIG. 11 is displayed again and the clips on the playlist selected at the box W61 of the screen of FIG. 9 are displayed at the box W82.

In this state, when the user inputs data into the boxes W71 through W73, W77 and W78 of the screen of FIG. 10, again imparts the attributes to the playlists at the icons I85 and I86 and adds or deletes the clips and the PGM at the icons I98 to I100 of the screen of FIG. 11, with respect to the playlists selected at the box W61 of the screen of FIG. 9, the playlists are changed, the transmission triggers are changed and the attributes are changed. After the playlists, the transmission triggers and the attributes are changed, when the user clicks the second icon displayed as “Save” from the left on the upper end of FIG. 10, information indicative of the changed playlists and transmission triggers and information on the changed attributes are stored again in the personal computer 11.

Upon visually confirming the content of each of the clips on the playlists on the monitor 14-2 by the icons I75 and I76 of the screen of FIG. 9, in case the user wants to change the playlist or the user wants to change the set transmission trigger or the user wants to change the attributes imparted to the playlists, the screens of FIGS. 10 and 11 are again displayed, and the playlists, the transmission triggers and the attributes can be changed.

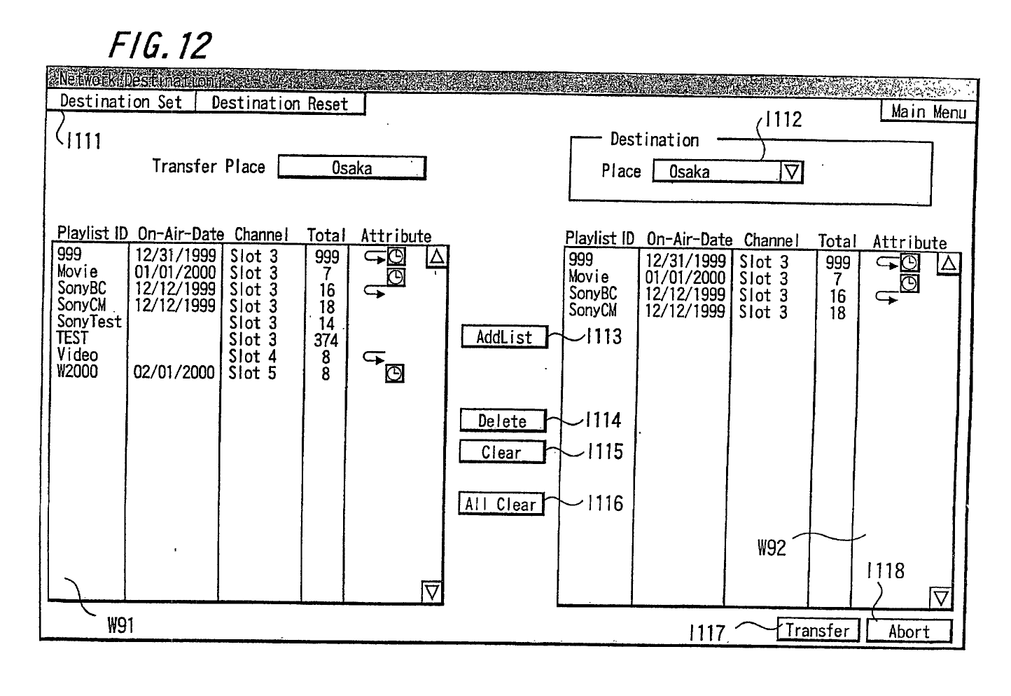

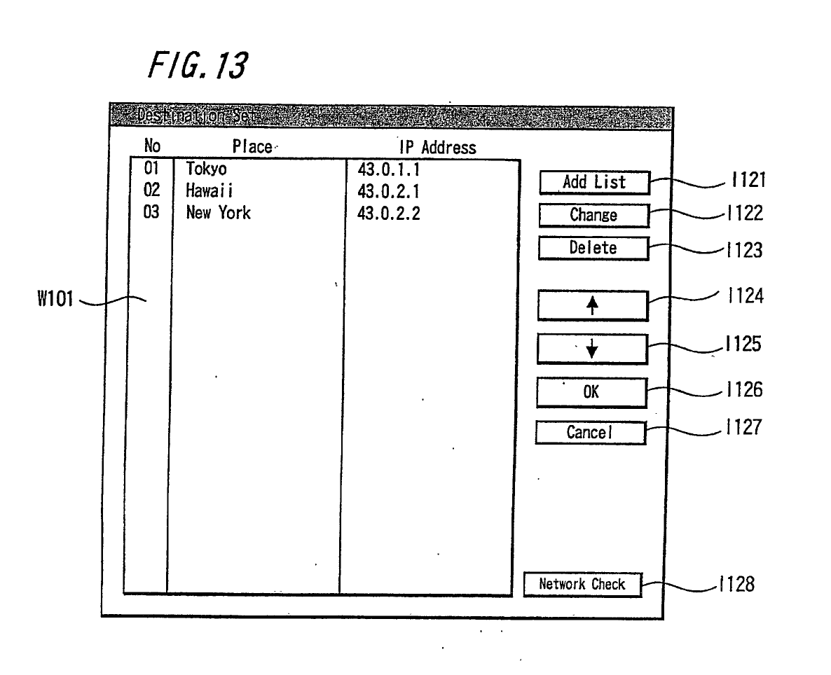

When the user clicks an icon I73 displayed at the upper end of the screen of FIG. 9, the current screen returns to the main menu screen of FIG. 3. On this main menu screen, there exists an icon (icon displayed as “NETWORK DISTRIBUTION”) I4 which enables the user to select the transfer of the playlist through the wide area network 3 from the master station 1 to an arbitrary slave station of the slave stations 2-1 to 2-n. When the user clicks this icon I4, there is displayed a playlist transfer screen shown in FIG. 12. on the upper end of the screen of FIG. 12, there exists an icon I111 which is used by the user to set the slave stations 2-1 to 2-n as the slave stations to which the playlists are transferred. When the user clicks this icon I111, there is displayed a transfer destination setting screen shown in FIG. 13.

On the screen of FIG. 13, there exists a box W101 in which, concerning slave stations (the slave stations 2-1 to 2-n) desired to be transfer destinations, the user inputs, by using the keyboard, information on the order of transferring the playlists, place names of areas in which the slave stations exist, IP (Internet protocol) addresses of the personal computer 31 of the corresponding slave stations and from which the user can also select any one or a plurality of arbitrary slave stations by the mouse out of the slave stations into which these information is inputted.

On the right-hand end of the screen of FIG. 13, there exist an icon I121 which is used by the user to add the slave station selected at the box W101 as a new transfer destination, an icon I122 which is used by the user to change inputted information with respect to the slave station selected at the box W101, an icon I123 which is used by the user to delete the slave station selected at the box W101 from the transfer destination, an icon I124 which is used by the user to move up the order in which the playlist is transferred to the slave station selected at the box W101, an icon I125 which is used by the user to move down the order in which the playlist is transferred to the slave station selected at the box W101, an icon I126 which is used by the user to register the contents set by the box W101 and the icons I121 to I125 and to return to the screen of FIG. 12 without registering the contents set at the icons I121 to I125, an icon I127 which is used by the user to return to the screen of FIG. 12 without registering the contents set by the icons I121 to I125 and an icon I128 which is used by the user to check whether or not the slave station selected at the box W101 is normally connected to the master station 1 via the wide area network 3.

When the user displays the screen of FIG. 13 and operates the apparatus, the respective slave stations 2-1 to 2-n are set as the playlist transfer destinations, respectively.

On the upper right-hand side of the screen of FIG. 12, there exists an icon I112 which is used by the user to select by the pull-down system the slave station (slave station set as the playlist transfer destination on the screen of FIG. 13) of the playlist transfer destination.

On the left-hand side of the screen of FIG. 12, there exist the box W91 in which the created playlists and the attributes imparted to the playlists are displayed in the form of a list and in which the user can select any one or a plurality of arbitrary playlists by the mouse.

On the center of the screen of FIG. 12, there exist an icon I113 which is used by the user to add the playlist selected at the box W91 to the transfer list to the slave station selected with the icon I112 (i.e., to create the transfer list to the slave station selected at the box W91), an icon I114 which is used by the user to delete the playlists from the transfer list, an icon I115 which is used by the user to delete the transfer lists with respect to the slave station currently selected and an icon I116 which is used by the user to delete the transfer lists with respect to all slave stations selected as the playlist transfer destinations.

On the right-hand side of the screen of FIG. 12, there exists a box W92 in which the playlists added to the transfer list by the icon I112 are displayed (i.e., the transfer lists thus created are displayed).

When the user displays the screen of FIG. 12 and operates the apparatus, the transfer lists are created with respect to any one or a plurality of arbitrary slave stations of the slave stations 2-1 to 2-n (i.e., transferred playlist are selected).

On the lower right-hand side of FIG. 12, there exist an icon I117 which is used by the user to start the transfer of the playlist and an icon I118 which is used by the user to abort the transfer.

When the user clicks the icon I117 after the transfer list is created, the selected playlists (playlists on the transfer list), trim information concerning the clips on the playlist, attribute information imparted to the playlists and the transmission trigger information concerning the clips on the playlists with respect to the slave stations the transfer lists of which are created out of the slave stations 2-1 to 2-n are transferred in the sequential order set on the screen of FIG. 13 from the personal computer 11 of the master station 1 through the Ethernet 16, the router 17, the wide area network 3, the router 36 of the corresponding slave station and the Ethernet 35 to the personal computer 31 of the corresponding slave station.

Concurrently therewith, in accordance with the selected playlist, the clips are recreated from the hard disk device 24 of the video server 12 of the master station 1. Then, these clips are transferred through the bus 26, the interface 25, the Ethernet 16, the router 17, the wide area network 3, the router 36 of the corresponding slave station and the Ethernet 35 to the video server 32 of the corresponding slave station.

Then, the playlists, the trim information, the attribute information and the transmission trigger information are stored in the personal computer 31 of the corresponding slave station and those clips are stored in the video server 32 of the corresponding slave station.

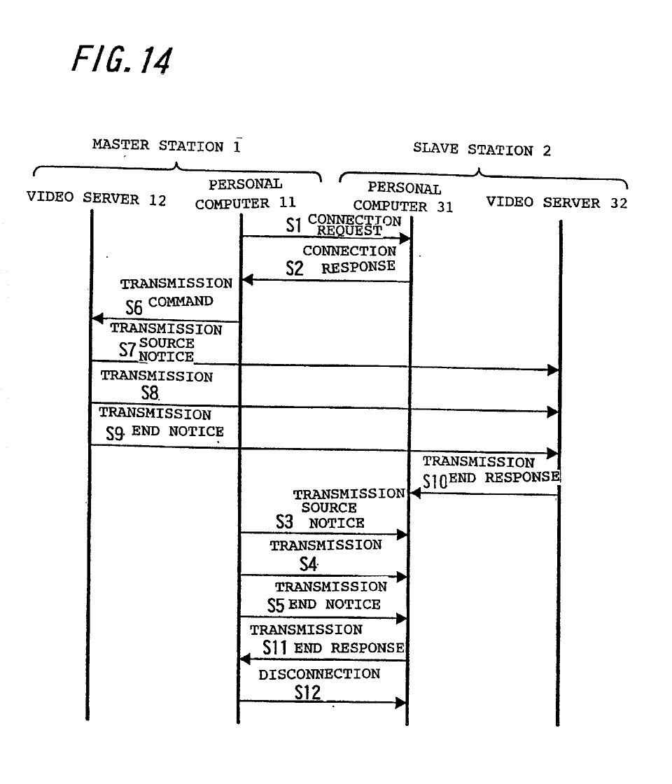

Communications between the master station 1 and the slave station 2 in the case of this transfer are executed by using an FTP (file transfer protocol). FIG. 14 shows an outline of a communication procedure in this transfer executed between the master station 1 and the slave station 2. First, the personal computer 11 of the master station 1 transmits a connection request to the personal computer 31 of the slave station whose order set on the screen of FIG. 13 is the first in the slave stations in which the transfer lists were created (step S1).

The personal computer 31 of the corresponding slave station returns a response to the connection request of this step S1 to the personal computer 11 of the master station 1 (step S2). Thus, a connection is established between the master station 1 and the corresponding slave station.

When the response to this step S2 is returned, the personal computer 11 of the master station 1 informs the personal computer 31 of the corresponding slave station of the transmission source (step S3) and transmits the playlists and the trim information concerning the corresponding slave station to the personal computer 31 (step S4). Then, after the above personal computer of the master station finishes the transmission, it informs the personal computer 31 of the end of the transmission (step S5).

Subsequently, the personal computer 11 of the master station 1 commands the video server 12 to transmit the clips concerning the slave station (step S6).

The video server 12 informs the video server 32 of the corresponding slave station of the transmission source based upon the command at this step S6 (step S7) and transmits the clips to the video server 32 (step S8). After the transmission is ended, the video server of the master station informs the video server 32 of the end of the transmission (step S9). The video server 32 transmits a response to the notice at this station S9 to the personal computer 31 of the corresponding station (step S10).

When receiving the response of the step S10, the personal computer 31 of the corresponding slave station transmits a response relative to the transmission end notices at the steps S5 and S8 to the personal computer 11 of the master station 1 (step S11).

When receiving the response of this step S11, the personal computer 11 of the master station 1 disconnects a connection between it and the personal computer 31 of the corresponding slave station (step S12). Then, the procedures of the steps S1 to S12 are repeated to each of the slave stations whose orders set on the screen of FIG. 13 come second and after out of the slave stations in which the transfer lists were created.

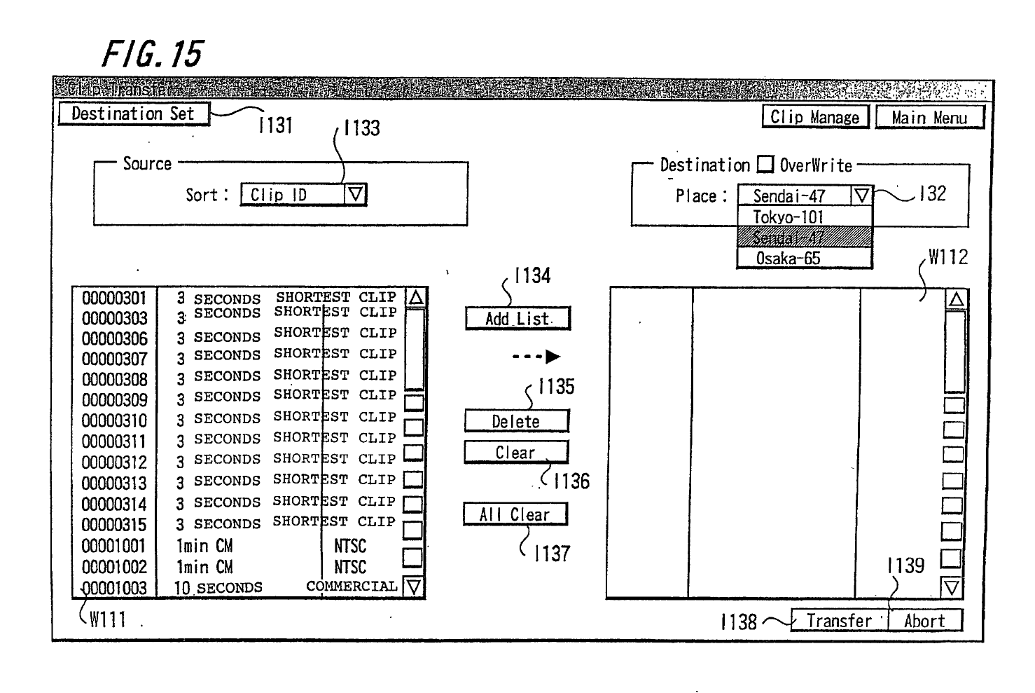

The clips are not always transferred together with the playlists but only the clips can be transferred. When the user clicks the aforementioned icon I41 displayed at the upper end of the screen of FIG. 7, there is displayed the screen of only the clip transfer as shown in FIG. 15.

On the upper end of the screen of FIG. 15, there exists an icon I131 which is used by the user to set the slave stations 2-1 to 2-n as the slave stations of the clip transfer destinations. When the user clicks this icon I131, there is displayed a transfer destination setting screen (not shown) similar to that of FIG. 13.

On the upper right-hand side of the screen of FIG. 15, there exists an icon I132 which is used by the user to select the slave station of the clip transfer destination (slave station set as the clip transfer destination in the slave stations 2-1 to 2-n) by a pull-down system.

On the left-hand side of the screen of FIG. 15, there exist a box Will in which the created clips are displayed in the form of a list and in which the user can select any one of a plurality of arbitrary clips with the mouse and an icon I133 which is used by the user to rearrange the clips displayed on the box Will.

On the center of the screen of FIG. 15, there exist an icon I134 which is used by the user to add the clips selected at the box W111 to the clip transfer list to the slave station selected by the icon I132 (i.e., to create the clip transfer list to the slave station selected at the box Will), an icon I135 which is used by the user to delete the clips from the clip transfer list, an icon I136 which is used by the user to delete the clip transfer list with respect to the slave station currently selected at the box Will and an icon I137 which is used by the user to delete the clip transfer lists with respect to all slave stations which are set to the clip transfer destinations.

On the right-hand side of the screen of FIG. 15, there exists a box W112 in which clips added to the clip transfer list by the icon I132 are displayed (i.e., the created clip transfer list is displayed).

When the screen of FIG. 15 is displayed and the user operates the apparatus, with respect to any one or a plurality of slave stations of the slave stations set as the clip transfer destinations, there are created respective clip transfer lists (i.e., transferred clips are selected).

On the lower right-hand side of the screen of FIG. 15, there exist an icon I138 which is used by the user to start the transfer of the clips and an icon I139 which is used by the user to abort the transfer of the clips.

When the user clicks this icon I138 after the clip transfer list is made, the clips selected with respect to each of the slave stations whose clip transfer lists were created in the slave stations set as the clip transfer destinations are recreated from the hard disk device 24 of the video server 12 of the master station 1, transferred through the bus 26, the interface 25, the Ethernet 16, the router 17 the wide area network 3, the router 36 of the corresponding slave station and the Ethernet 35 to the video server 32 of the corresponding slave station and thereby stored in the video server 32.

Next, the manner in which each slave station 2 is placed in the transmission standby and in which each slave station 2 starts the transmission of the material in this network CATV system will be described.

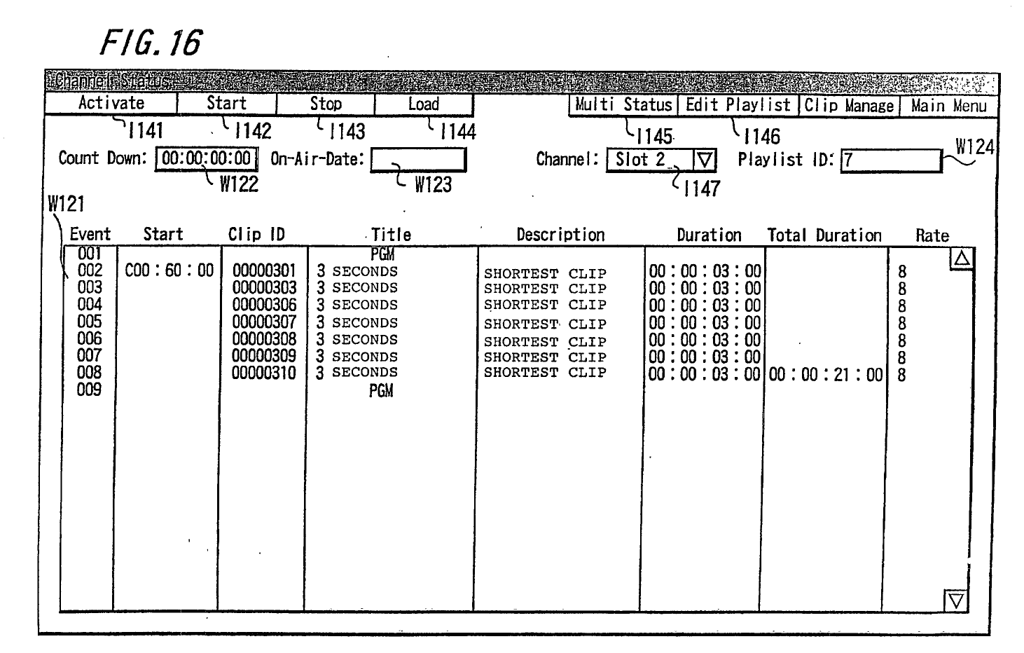

Since the same application software as that of the personal computer 11 of the master station 1 is installed in the personal computer 31 of each slave station 2, the same main menu screen is displayed on the personal computer 31. On this main menu screen, there exists an icon (icon displayed as “CHANNEL STATUS”) I5 which enables the user to select the start of the transmission standby and the start of the transmission. When the user clicks this icon I5, there is displayed a screen shown in FIG. 16.

On the upper end of the screen of FIG. 16, there exist an icon I142 which is used by the user to start the transmission of the clips and an icon I143 which is used by the user to stop the transmission of the clips.

On the upper end of the screen of FIG. 16, there exist an icon I114 which is used by the user to open a window in which the playlists transferred from the master station 1 are displayed in the form of a list and an icon I46 which is used by the user to display a similar playlist changing screen obtained when the icon I72 is clicked under the condition that the playlist is selected in the box W61 on the screen of FIG. 8 with respect to the playlist selected from this window by the mouse. If the playlist, which should be changed or deleted before transmission, is contained in the playlists transferred from the master station 1, then when this screen is displayed and the user operates the apparatus, the slave station 2 side can change or delete the corresponding playlist.

On the upper end of the screen of FIG. 16, there exist an icon I145 which is used by the user to open a window in which the situation in which each output slot of the video server 32 is currently in use is displayed and an icon I147 which is used by the user to make a selection of from which output slot of the video server 32 clips placed in the transmission standby on the playlist are to be outputted by the pull-down system. When the output slot selected by the icon I83 on the screen of FIG. 10 or the icon I102 on the screen of FIG. 11 cannot be used on the master station 1 side from a standpoint of the situation in which each output slot of the video server 32 is currently in use, the output slot can be selected again on the slave station 2 side.

On the screen of FIG. 16, there exist a box W121 in which transmission triggers, IDs, titles and so on of the clips on the playlist placed in the transmission standby are displayed in the form of a list in the sequential order of the event numbers, a box W122 in which a remaining time required until the transmissions of those clips are completed is displayed, a box W123 in which dates at which those clips are to be transmitted are displayed and a box W124 in which the ID of that playlist is displayed.

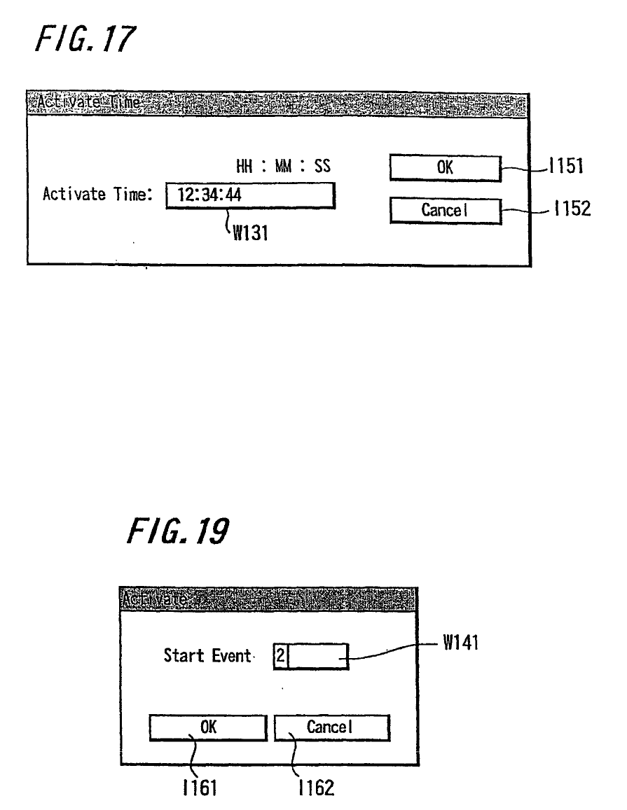

On the other hand, on the main menu screen, there exists an icon I6 displayed as “UTILITY”. When the user clicks this icon I6, though not shown, there is displayed a utility screen in which an icon displayed as “Auto Activate Set” exists. When the user clicks the icon displayed as “Auto Activate Set”, there is displayed a transmission standby time setting screen shown in FIG. 17.

On the screen of FIG. 17, there exist a box W131 in which the user may input a time at which the transmission standby is effected automatically, an icon I151 which is used by the user to determine and register the time inputted to the box W131 and to return to the utility screen and an icon I152 which is used by the user to cancel the time inputted to the box W131 and to return to the utility screen.

When the screen of FIG. 17 is displayed and the user operates the apparatus, a time at which the transmission standby is automatically effected is set at each slave station. As this time, it is desirable that a time in the midnight in which a broadcast of a day is finished or a time in the early morning in which a broadcast of a day is started should be set.

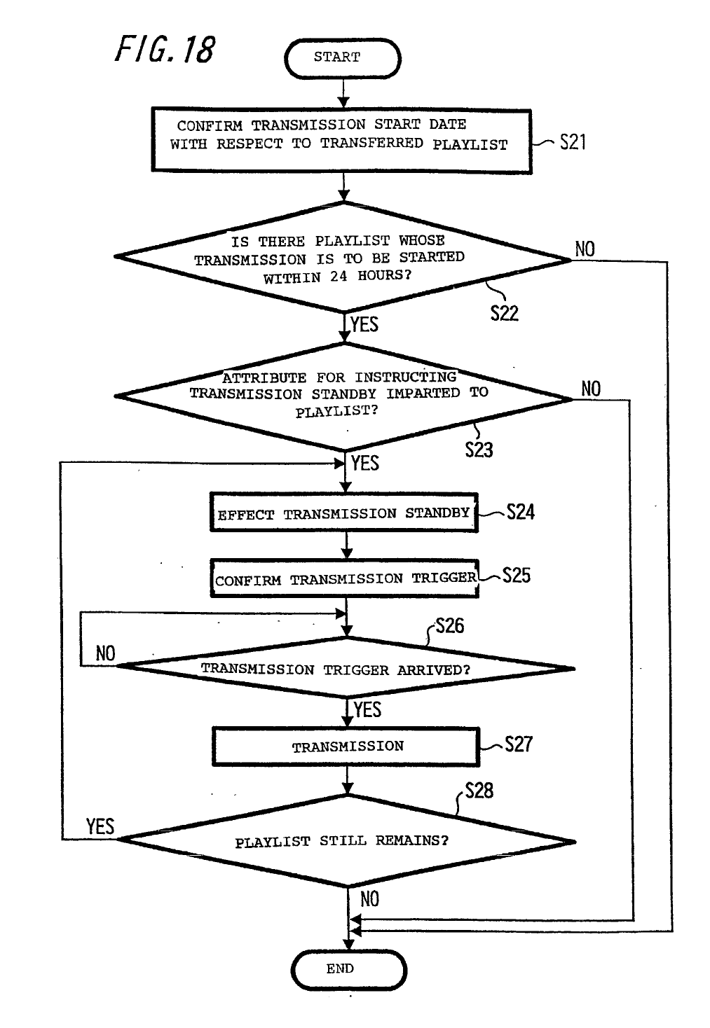

When a time at which the transmission standby is automatically effected is set, the personal computer 31 starts a processing shown in FIG. 18 at the set time every day. In this process, first, at the set time, with respect to respective playlists transferred from the master station 1 (except the playlists deleted on the slave station 2 side), dates at which the transmission of the clips is to be started (dates inputted to the boxes W74 and W84 of the screens of FIGS. 10 and 11 on the master station 1 side and the times inputted to the box W72 of FIG. 10, and these dates and times can be changed on the slave station 2 side as the changes of the playlists) are confirmed (step S21).

Then, it is determined whether or not there exist playlists in which the dates at which the transmission of clips is to be started fall within the same time of the next day (i.e., fall within 24 hours) (step S22).

If not, then control is ended. If on the other hand there exist the playlists, then it is determined based upon attribute information transferred from the master station 1 (when this attribute is re-imparted as the change of the playlist on the slave station 2 side, attribute information is such re-imparted attribute information) whether or not these playlists contain a playlist to which the attribute for instructing the transmission standby attribute imparted by the icon I86 on the screen of FIG. 10 on the master station 1 side) is imparted.

If not, then control is ended. If on the other hand there exists such a playlist, then based upon the playlist having the earliest transmission start time in these playlists, there is executed the transmission standby in such a manner that the transmission of clips on the playlist may immediately be started as soon as the transmission trigger arrives (step S24).

Subsequently, the transmission trigger (transmission trigger set at the box W72 on the screen of FIG. 10 by the master station 1 side) with respect to the clip in which the transmission standby is executed is confirmed based upon the transmission trigger information transferred from the master station 1 (when this transmission trigger is newly set as the change of the playlist by the slave station 2 side, transmission trigger information is the newly set transmission trigger information) (step S25). Then, it is determined whether or not the transmission trigger has arrived (step S26).

When the contents of the transmission trigger indicate a fixed time (when a character “C” is inputted to the left-hand side of the transmission start scheduled time of the box W72 on the screen of FIG. 10 by the master station 1 side), if this transmission start scheduled time arrives, then it is determined that the transmission trigger has arrived.

On the other hand, when the contents of the transmission trigger indicate the transmission instruction signal (GPI signal) from the host apparatus (when the user inputs only the transmission start scheduled time into the box W72 on the screen of FIG. 10), if this GPI signal is received, then it is determined that the transmission trigger has arrived.

When on the other hand the contents of the transmission trigger indicate the operation of the personal computer 31 (when the user inputs the character “C” on the left-hand side of the transmission start scheduled time into the box W72 on the screen of FIG. 10), if the screen of FIG. 12 is displayed on the personal computer 31 and the user clicks the icon I14, then it is determined that the transmission trigger has arrived.

If it is determined that the transmission trigger has arrived, then the transmission of the clips in which the transmission standby is executed is started (step S27). Specifically, the clips are recreated from the hard disk device within the video server 32 in the sequential order of the event numbers and these clips are transferred to the output slot within the video server 32 (although this output slot is the output slot selected on the master station 1 side, a new output slot can be selected on the master station 2 side as described before). Then, these clips are decoded and outputted from that output slot, whereby these clips are transmitted from the head end 34.

When the PGMs are added to the playlists as shown in FIG. 10 so that the transmission triggers are set to each group of the clips, the steps S25 to S27 are executed in each group of the clips.

If it is determined based upon the attribute information transferred from the master station 1 (when a new attribute is imparted as the change of the playlist by the slave station 2 side, such newly imparted attribute information) that the attribute for instructing the repetitive transmission is imparted to the playlist, then the clips are repeatedly recreated/outputted from the video server 32 in the sequential order of the event numbers at the step S27.

When trim information with respect to the clips in which the transmission standby is executed are transferred from the master station 1, at this step S27, the clips recorded on the video server 32 are edited based upon the trim information (edited portions from the IN-point to the OUT-point defined by the trim information are sliced) and recreated from the video server 32.

After the transmission of the clips has been completed as described above, it is determined whether or not there still remain playlists whose transmission start scheduled date falls within 24 hours and to which the attributes for instructing the transmission standby are imparted and playlists in which the transmission standby is not yet executed and in which the transmission of the clips is not yet executed (step S28).

If it is determined that there still remain the above playlists, then control goes back to the step S24, whereat the transmission standby is executed and the clips are transmitted with respect to the remaining playlists. Then, after the transmission standby has been completed and the transmission of the clips has been completed with respect to all of the playlists, control is ended.

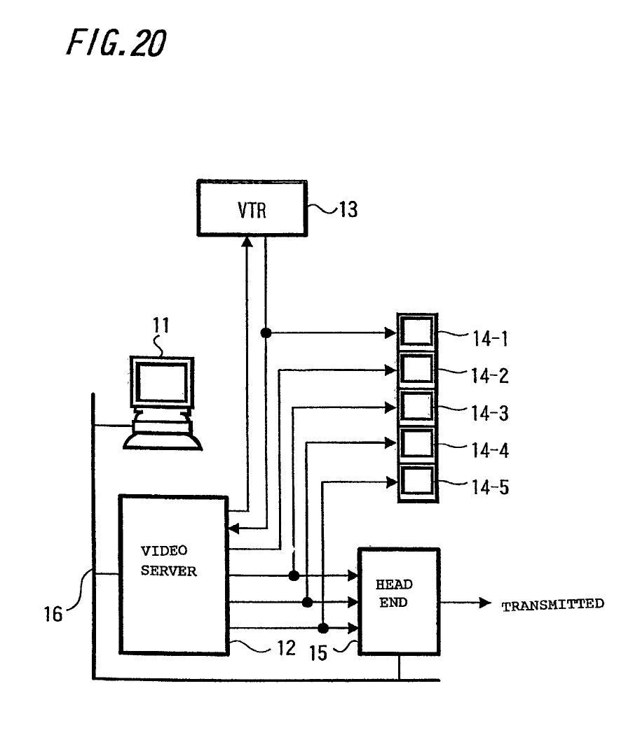

The transmission standby is not always executed automatically at the time set on the screen of FIG. 17 as described above, and the transmission standby can be executed in a manual fashion. When the user clicks the aforementioned icon I141 displayed on the upper end of the screen of FIG. 16, there is displayed a screen which is used by the user to execute the transmission standby in a manual fashion as shown in FIG. 19.

On the screen of FIG. 19, there exist a box W141 which is used by the user to input a transmission start event number, an icon I161 which is used by the user to execute the transmission standby in a manual fashion and to return to the screen of FIG. 16 and an icon I162 which is used by the user to cancel the manual transmission standby and to return to the screen of FIG. 16.

When the screen of FIG. 19 is displayed and the user operates the apparatus, the user can execute the transmission standby at each slave station 2 in a manual fashion.

When the screen of FIG. 16 is displayed under the state that the transmission standby is executed, the clips on the playlists are displayed in the box W121 in the form of a list. Moreover, the remaining times required until the transmission of those clips is completed, the transmission program dates of those clips and the playlist IDs are displayed in the boxes W122, W123, W124, respectively.

When the contents of the transmission trigger indicate a constant time, the character C and the transmission start scheduled time are displayed in the column of the transmission trigger at the box W121. FIG. 16 shows the state in which 6:00 is the transmission trigger so that characters “C00:06:00” are displayed on this column.

On the other hand, when the contents of the transmission trigger indicate the GPI signal, only the character “K” is displayed in this column. When the contents of the transmission trigger indicate the operations of the personal computer 31, this column is made blank.

Of the clips displayed at the box W121 in the form of a list, the clip which is currently placed in the transmission standby (a clip of an event number 002 in the state of FIG. 16) is displayed in color different from those of other clips.

As described above, according to this network CATV system, in the master station 1, when the user operates the personal computer 11, the clips are created/recorded from the AV data recorded on the VTR 13 by the video server 12. Further, when the user operates the personal computer 11, there are created trim information concerning clips, playlists indicating clip transmission programs and transfer lists of each slave station 2.

Then, once the user operates the personal computer 11 (when the user clicks the icon I105 on the screen of FIG. 12), the selected playlists, the clips on the playlists and the trim information concerning the clips are transferred through the wide area network 3 to all slave stations in which the transfer lists are created out of each slave station 2.

Accordingly, unlike the prior art, a troublesome work consuming a lot of time in which materials are re-recorded on the video tape in the sequential order of the materials to be transmitted and in which the above video tape is transported from the master station 1 to each slave station 2 is not needed, and the materials can be distributed from the master station 1 to each slave station 2 in a short time period by a simple work.

Since the master station 1 records the clips on the video server 12 using the hard disk which is the nonlinear-accessible recording medium, the clips on the playlist can be quickly recreated/outputted from the video server 12 and then transferred to each slave station 2.

Since each slave station 2 records the clips transferred from the master station 1 on the video server 32 using the hard disk, the clips can be quickly recreated/outputted from the video server 32 and then transmitted in the sequential order in which the clips are on the playlist.

Since the clip, or material created by compressing the AV data is transferred through the wide area network 3 from the master station 1 to each slave station 2, a transfer time can be reduced and a burden imposed upon the wide area network 3 also can be alleviated.

Since the trim information also is transferred, each slave station 2 can edit (partly slice) the transferred clip and transmit the same based upon this trim information.

When the master station 1 creates the playlist, since the time frame (PGM) that can freely be used by each slave station 2 can be added to the playlist, the material originally created by each slave station 2 (clip recorded on the hard disk device after it has been inputted/encoded by the video server 32) can be transmitted during this time frame. Accordingly, the slave station 2 in each area can transmit a local commercial of each area during a commercial time while it is transmitting a common program created by the master station 1.

Conversely, when the slave station 2 does not create the material originally but transmits only the material distributed from the master station 1, since the AV data which is the source to create a material need not be inputted to the video server 32 of the slave station 2, the input slot need not be mounted on the video server 32. Accordingly, since five outputs slots can be mounted on the video server 32, it is possible to improve a transmission capability of the slave station 2.

In this network CATV system, once the screen of FIG. 17 is displayed on the personal computer 31 and the transmission standby time is set, the transmission standby based on the playlist transferred from the master station 1 can automatically be carried out at a fixed time every day on the slave station 2 side without an operation done by staff in the broadcasting station unlike the prior art.

Accordingly, a burden imposed upon an operation of the staff of the slave station 2 can be alleviated, and it is possible to prevent a situation in which the materials on the playlist cannot be transmitted unintentionally from the slave station 2 due to a mistake.

The slave station 2 side need not set the transmission trigger but the transmission trigger set on the master station 1 side arrives so that the clip in which the transmission standby is executed is transmitted from the slave station 2. Accordingly, a burden imposed upon an operation of the staff of the slave station 2 can be alleviated from this standpoint.

Since not only the playlists but also the clips on the playlists are transferred through the wide area network 3 from the master station 1 to the slave station 2, the slave station 2 side can automatically receive the distributed playlists and the clips, and the transmission standby based on the playlists can be executed automatically and the transmission of the clips required when the contents of the transmission trigger are the fixed time and the transmission instructing signal (GPI signal) from the host apparatus can be executed automatically without an operation of the staff of the broadcasting station.

Accordingly, when the slave station 2 does not create the material independently but transmits the clips distributed from the master station 1, the slave station 2 can be one without humans in attendance after a transmission standby time has been set upon introduction of the system.

When the slave station 2 does not create the material independently as described above, since the AV data which is the source to create the material need not be inputted to the video server 32 of the slave station 2, the input slot need not be mounted on the video server 32. Accordingly, since five output slots can be mounted on the video server 32, it is possible to improve the transmission capability of the slave station 2.

Since the trim information concerning the clips is transferred from the master station 1 to the slave station 2, the transferred clips are automatically edited (partly sliced) by the slave station 2 based upon this trim information and then transmitted.

Since the playlists and the clips are transferred through the wide area network 3 to each slave station 2 once the user operates the personal computer 11 of the master station 1, the materials can be distributed from the master station 1 to each slave station 2 in a short period of time by a simple work.

Since the master station 1 records the clips on the video server 12 using the hard disk which is the nonlinear-accessible recording medium, the clips on the playlist can quickly be recreated/outputted from the video server 12 and then transferred to each slave station 2.

Since each slave station 2 records the clips transferred from the master station 1 on the video server 32 using the hard disk, the clips can quickly be recreated/outputted from the video server 32 in the sequential order of them being on the playlists and then transmitted.

Since the clips which are created by compressing the AV data are transferred through the wide area network 3 from the master station 1 to each slave station 2, a transfer time can be reduced and a burden imposed upon the wide area network 3 also can be alleviated.

Next, the manner in which the transmission standby is executed and the transmission of the material is started when the master station 1 of FIG. 1 transmits the material thus created from its own station will be described.

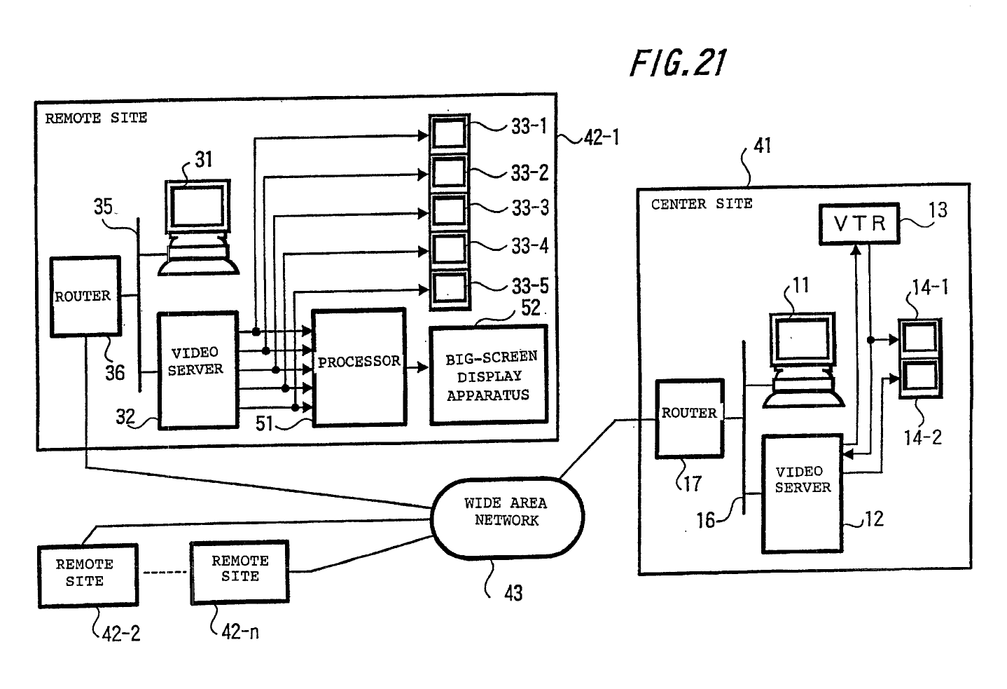

FIG. 20 shows only a portion of a transmission system of the master station 1 in the CATV system of FIG. 1. When the user clicks the icon I5 on the main menu screen of FIG. 3 in the personal computer 11 of the master station 1, there is displayed the screen of FIG. 16. When the user clicks the icon I6 on the main menu screen of FIG. 3 and then clicks the icon “Auto Activate Set” on the aforementioned utility menu screen, there is displayed the screen of FIG. 17.

When the master station 1 transmits the created material from its own station, after the personal computer 11 displayed the screens of FIGS. 4 to 11 and the clips and the playlists have been created, the transmission trigger has been set and the attributes have been imparted to the playlists, the screen of FIG. 17 is displayed and a time at which the transmission standby is executed automatically is set. As this time, it is desirable that a time in the midnight in which a broadcast of a day is ended or a time in the early morning in which a broadcast of a day is started should be set.

When a time at which the transmission standby is executed automatically is set, the personal computer 11 starts the processing shown in FIG. 18 at the set time every day. This processing will be described again in correspondence with the operations in which the master station 11 creates the clips and the playlists, sets the transmission trigger and imparts the attributes to the playlists.

First, at this set time, with respect to the playlists thus created (except for the playlists deleted from the screen displayed when the user clicks the icon I46 on the screen of FIG. 16), the user visually confirms the clip transmission start scheduled date (although this date is the date inputted to the boxes W74 and W84 on the screens of FIGS. 10 and 11 and this time is the time inputted to the box W72 of FIG. 10, the above date and time can be changed as the change of the playlist on the screen displayed when the user clicks the icon I46) (step S21).

Then, it is determined whether or not these playlists contain a playlist in which the clip transmission start scheduled date falls upon the same time of the next day (i.e., the clip transmission start scheduled date falls within 24 hours) (step S22).

If not, then control is ended. If on the other hand the playlists contain such a playlist, then it is determined whether or not those playlists contain a playlist to which a transmission standby instructing attribute is imparted (although this attribute is imparted by the icon I86 on the screen of FIG. 10, this attribute can be changed as the change of the playlist on the screen displayed when the user clicks the icon I46) (step S23).

If not, then control is ended. If on the other hand those playlists contain such a playlist, then based upon the playlist having the earliest transmission start time in those playlists, the transmission standby is executed in such a manner that the transmission of the clips on the playlist may immediately be started in response to the arrival of the transmission trigger (step S24).

Subsequently, the user visually confirms the transmission trigger with respect to the clips in which the transmission standby is executed (although this transmission trigger is the transmission trigger set at the box W72 on the screen of FIG. 10, this transmission trigger can be newly set as the change of the playlist on the screen displayed when the user clicks the icon I46) (step S25). Then, it is determined whether or not the transmission trigger arrived (step S26).

When the contents of the transmission trigger instruct a constant time (when the character “C” is inputted to the left-hand side of the transmission start scheduled time of the box W72 on the screen of FIG. 10), if this transmission start scheduled time arrives, then it is determined that the transmission trigger has arrived.

On the other hand, when the contents of the transmission trigger instruct the transmission instructing signal (GPI signal) from the host apparatus (when the user inputs only the transmission start scheduled time into the box W72 on the screen of FIG. 10), if this GPI signal is received, then it is determined that the transmission trigger arrived.

On the other hand, when the contents of the transmission trigger instruct the operations of the personal computer 11 (when the character “C” is inputted to the left-hand side of the transmission start scheduled time of the box W72 on the screen of FIG. 10), if the screen of FIG. 12 is displayed on the personal computer 11 and the user clicks the icon I142, then it is determined that the transmission trigger arrived.

In this manner, if it is determined that the transmission trigger has arrived, then the transmission of the clips in which the transmission standby is executed is started (step S27). Specifically, the clips are recreated from the hard disk device within the video server 12 in the sequential order of the event numbers and the clips are transferred to the output slot within the video server 12 (the output slot selected by the icon I83 on the screen of FIG. 10 or by the icon I102 on the screen of FIG. 11). Then, the output-slot decodes and outputs these clips, whereby the head end 15 transmits those clips.

Also in this case, when the PGM is added to the playlists as shown in FIG. 10 so that the transmission triggers are set in each group of the clips, the steps S25 to S27 are executed in each group of the clips.

Also in this case, when the attribute for instructing the repetitive transmission is imparted to the playlists, at this step S27, the clips are repeatedly recreated/outputted from the video server 12 in the sequential order of the event numbers.

Also in this case, when the trim information is created with respect to the clips in which the transmission standby is executed, based upon the trim information, at this step S27, of the clips recorded on the video server 12, only the clips which fall within a range of corrected edit points (IN-point and OUT-point) are recreated from the video server 12.

When the transmission of the clips is completed as described above, it is determined whether or not there still remain playlists in which the transmission start scheduled date falls within 24 hours and to which the attribute for instructing the transmission standby is imparted and in which the transmission standby is not executed and in which the clips are not transmitted (step S28).

If it is determined that there still remain the playlists, then control goes back to the step S24, whereat the transmission standby is executed and the clips are transmitted with respect to the remaining playlists. Then, after the transmission standby has been completed and the transmission of the clips have been completed with respect to all of the playlists, control is ended.

When the user clicks the icon I141 displayed on the upper end of the screen of FIG. 16 in the personal computer 11 of the master station 1, since the screen for executing the transmission standby in a manual fashion as shown in FIG. 19 is displayed, the user can carry out the transmission standby in a manual fashion.

When the screen of FIG. 16 is displayed in the personal computer 11 of the master station 1 in the state that the transmission standby is executed, as mentioned before, the clips on the playlists in which the transmission standby is executed are displayed at the box W121 in the form of a list, a remaining time required until the transmission of these clips is completed, transmission program dates of these clips and an ID of such playlist are displayed on the boxes W122, W123, W124, respectively.

As described above, according to the transmission system of the master station 1, once the screen of FIG. 13 is displayed on the personal computer 11 and the transmission standby time is set, the transmission standby based on the playlists thus created can automatically be executed at a fixed time every day without an operation done by the staff in the broadcasting station unlike the prior art.

Accordingly, the burden imposed upon an operation of the staff in the broadcasting station can be alleviated, and it is possible to prevent the situation in which the materials on the playlist cannot be transmitted due to a mistake unintentionally.

When the transmission trigger with respect to the clips in which the transmission standby is executed arrives, the transmission of the clips can be started automatically. As a result, the burden imposed upon the work can be alleviated more.

Further, since the trim information is created, the clips on the playlist can be transmitted while the IN-point and the OUT-point are being corrected based upon this trim information.

Furthermore, since the clips are recorded on the video server 12 using the hard disk, the clips can quickly be recreated/outputted from the video server 12 in the sequential order of them being on the playlist and then transmitted.

While the present invention is applied to the CATV service in the above example, as another example, the present invention is applied to a service for transmitting materials by using a big-screen display installed at the public place.

FIG. 21 shows an example of an overall configuration of a system in which the present invention is applied to a transmission service using a big-screen display at the public place (this system is referred to as a network billboard system from a standpoint of using a big-screen display as a billboard (billboard)) and in which parts common to those of FIG. 1 are denoted with identical reference numerals.

In this network billboard system, a center site 41 and a plurality of remote sites 42 (42-1 to 42-n) are connected via a wide area network 43 by using INS1500 which is an ISDN service of NTT, for example. The respective remote sites 42 are located at places in which a big-screen display is installed, such as facilities of Japanese or overseas railroad stations/airports. The center site 41 is located within an editing room distant from those facilities.

In each remote site 42, materials outputted from the respective output slots of the video server 32 are displayed on the monitors 33-1 to 33-5 and are also supplied to a video processing processor 51. Under control of this processor 51, the above materials are displayed on a big-screen display device 52, for example, in the state in which a picture is divided.

Since the material is not transmitted from the center site 41 unlike the master station 1 of FIG. 1, it is sufficient that only one output slot may be mounted on the video server 12 in order to output the created clips and to visually confirm them on the monitor 14-2.

Since a material is not created by the remote site 42 unlike the slave station 2 of FIG. 1, an input slot need not be mounted on the video server 32.

According to this network billboard system, the personal computer 11 of the center site 41 executes the processings shown in FIGS. 3 to 15, whereby the materials can be distributed to the big-screen displays installed at a plurality of places in a short period of time by a simple work unlike the prior art which requires time-consuming and troublesome work in which the materials are re-recorded on a cassette tape for a streamer in the sequential order of the materials to be transmitted and in which such video tape is carried from the editing room to the places in which the big-screen displays are installed.

Further, according to this network billboard system, the personal computer 11 of the center site 41 executes the processings shown in FIGS. 3 to 15 and the personal computer 31 of the remote site 42 executes the processings shown in FIGS. 16 to 18, whereby the distributed playlists and clips can be received automatically, the transmission standby based upon the playlist can be carried out automatically and the clips obtained when the contents of the transmission trigger instruct a fixed time, for example, can be transmitted automatically without man's work.

Accordingly, a burden imposed upon an operation of a person in charge who visit the places in which the displays are installed can be alleviated, and also it is possible to prevent a situation in which the clips on the playlist cannot be transmitted due to a mistake unintentionally. After a transmission standby time has been set when the system is introduced, the places in which the displays are installed can constantly be automated.

In the above example, the master station 1 or the center site 41 creates the clips by inputting the AV data recorded on the single VTR 13 into the video server 12. However, as another example, two input slots 22 or more may be mounted on the video server 12, whereby the clips may be created by inputting the AV data recorded on two VTRs or more into the video server 12. Further, the clips may be created by inputting the AV data, transmitted through the network to the master station, into the video server 12 except the AV data recorded on the VTR.

Video servers used by the master station 1, the slave station 2, the center site 41 and the remote site 42 in the network CATV system and the network billboard system to which the present invention is applied may have configurations different from that of the video server shown in FIG. 2 (e.g., video servers on which four input and output slots or less or six input and output slots or more in total can be mounted or video servers which can record/reproduce clips by using an optical disk apparatus and a semiconductor memory). Further, clips may be recorded/recreated by using a proper recording and reproducing apparatus other than the video server.

While one master station 1 (or one center site 41) and a plurality of slave stations 2 (or a plurality of remote sites 42) are connected together via the wide area network 3 (or the wide area network 43) in the above example, the present invention is not limited thereto and one master station 1 (or one remote site 41) and one slave station 2 (or one remote site 42) may be connected together via the wide area network 3 (or the wide area network 43) or a plurality of master stations 1 (or a plurality of center sites 41) and one or a plurality of slave stations 2 (or one or a plurality of remote sites 42) may be connected together via the wide area network 3 (or the wide area network 43).

The present invention is not limited to the CATV service and the transmission service using the big-screen display installed at the public place and may be applied to all cases in which a place for creating transmitted data (materials or the like) and a place for transmitting the transmitted data are located distant from each other and all cases in which a place for creating a playlist for instructing a transmission schedule of data and a place for transmitting data based upon the playlist thus created are located distant from each other, such as when contents of lectures done by an instructor are recorded by a VTR and a material which is created based upon the recorded contents in the editing room is transmitted by using a big-screen display apparatus in a classroom of a university, a city hall and the like.

The present invention is not limited to the transmission system of the broadcasting station and may be applied to all cases in which a playlist for indicating a transmission schedule of data is created and the transmission standby is executed based upon the playlist.

The present invention is not limited to the above examples and may take various modifications without departing from the gist of the present invention.

As illustrated in the above examples, according to the data transmission apparatus and the data transmission method of the present invention, data can be distributed from the data creating section which creates transmitted data (material, etc.) to the data transmission section which transmits the above data in a short period of time by simple work without a time-consuming and troublesome work in which data are re-recorded on a portable medium in the sequential order of the data to be transmitted and the portable medium is carried from the data creating section to the data transmission section.

Accordingly, when the present invention is applied to the CATV service, for example, the material can be distributed from the master station which creates the material to the slave station which transmits the material in a short period of time by simple work.

Alternatively, when the present invention is applied to the transmission service using the display installed at the public place, for example, the material can be distributed from the editing room which creates the material to the display which transmits the material in a short period of time by simple work.

According to this data transmission apparatus and this data transmission method, there can be achieved an effect in which data can be distributed to a plurality of data transmission sections in a short period of time by simple work.

According to this data transmission apparatus and this data transmission method, there can be achieved effects in which the data creating section can quickly reproduce and transfer data on the playlist from the recording and reproducing means and in which the data transmission section can quickly reproduce and transmit data from the recording and reproducing means in the sequential order of data being on the playlist.

Further, according to this data transmission apparatus and this data transmission method, there can be achieved effects in which a time during which data are transferred to the data transmission section can be reduced and in which a burden imposed upon the network can be alleviated.

Furthermore, according to this data transmission apparatus and this data transmission method, there can be achieved an effect in which the data transmission section can edit and transmit data, transferred from the data creating section, based upon the edit information transferred from the data creating section.

Next, according to the data transmission apparatus and the transmission standby method of the present invention, in the data transmission section side, the transmission standby based upon the playlist transferred from the playlist creating section can automatically be executed at a fixed time without man's work.

As a result, there can be achieved an effect in which a burden imposed upon an operation of the data transmission section can be alleviated. There can also be achieved an effect in which it is possible to prevent a situation in which the data on the playlist cannot be transmitted from the data transmission section by a mistake unintentionally.

Accordingly, when the present invention is applied to the CATV service, for example, since the transmission standby based upon the playlist distributed from the master station can automatically be executed in the slave station side without an operation of the staff in the broadcasting station unlike the prior art, a burden imposed upon an operation of the staff in the slave station can be alleviated, and it is possible to prevent a situation in which the materials on the playlist cannot be transmitted from the slave station by a mistake unintentionally.

Alternatively, when the present invention is applied to the transmission service using the display installed at the public place, for example, since the transmission standby based upon the playlist distributed from the editing room can automatically be executed in the place wherein the display is installed without an operation of a person who visited the place in which the display is installed, a burden imposed upon an operation of the above person can be alleviated, and it is possible to prevent a situation in which the materials on the playlist cannot be transmitted by a mistake unintentionally.

According to this data transmission apparatus and this transmission standby method, once a time is set, the data transmission section side automatically executes the transmission standby based upon the playlist transferred from the playlist creating section at a fixed time every day without man's work.

As a result, a burden imposed upon an operation of the data transmission section can be alleviated more, and it is possible to more effectively prevent the situation in which the data on the playlist cannot be transmitted any longer.

Further, according to this data transmission apparatus and this transmission standby method, without setting the transmission trigger in the data transmission section side, data on which the transmission standby is effected is transmitted from the data transmission section each time the transmission trigger set at the playlist creating section side arrives. Accordingly, from this standpoint also, there can be achieved an effect in which a burden imposed upon an operation of the data transmission section can be alleviated.

Furthermore, according to this data transmission apparatus and this transmission standby method, since not only the playlists but also data on the playlists are transferred through the network from the playlist creating section to the data transmission section and recorded on the data transmission section, the data transmission section side can automatically receive the distribution of the playlists and the data, can automatically execute the transmission standby based upon the playlists and can automatically transmit data without man's work when the contents of the transmission trigger instruct the fixed time, for example.

Accordingly, when the data transmission section does not create data independently but transmits only the distributed data, there can be achieved an effect in which the data transmission section can be automated after a time has been set once.

Furthermore, according to this data transmission apparatus and this transmission standby method, there can be achieved effects in which the playlist creating section can quickly reproduce and transfer data on the playlist from the recording and reproducing means and the data transmission section can quickly reproduce and transmit data from the data recording and reproducing means in the sequential order of the data on the playlist.

Next, according to the transmission standby apparatus and the transmission standby method of the present invention, the transmission standby based upon the created playlist can automatically be executed at a time set by the time setting means without man's work.

As a result, there can be achieved an effect in which a burden imposed upon an operation can be alleviated. There can also be achieved an effect in which a situation in which data on the playlist cannot be transmitted due to a mistake unintentionally can be prevented.

Accordingly, when the present invention is applied to the transmission system in the broadcasting station, for example, since the transmission standby of the materials based upon the created playlist can automatically be executed without an operation of staff in the broadcasting station unlike the prior art, a burden imposed upon an operation of the staff in the broadcasting station can be alleviated, and it is possible to prevent a situation in which the materials on the playlist cannot be transmitted due to a mistake unintentionally.

Further, according to this transmission standby apparatus and this transmission standby method, once a time is set by the time setting means, the transmission standby based upon the created playlist can automatically be executed at a fixed time every day without man's work.

As a result, there can be achieved effects in which a burden imposed upon an operation can be alleviated more and in which it is possible to more effectively prevent a situation in which the data on the playlist cannot be transmitted any longer.

Next, according to the transmission start apparatus and the transmission start method of the present invention, the transmission of data can automatically be started each time the transmission trigger with respect to the data on which the transmission standby is effected arrives. As a result, there can be achieved an effect in which a burden imposed upon an operation can be alleviated more.

Furthermore, according to this transmission start apparatus and this transmission start method, there can be achieved an effect in which the data on the playlist can quickly be recreated and transferred from the recording and reproducing means in the sequential order of the data on the playlist.

1. A data transmission apparatus in which a data creating section for creating data to be transmitted and a data transmission section for transmitting said data are connected via a network, being characterized in that
said data creating section comprises:
a recording and reproducing means for recording created data;
a playlist creating means for creating playlists showing a transmission schedule of data recorded on said recording and reproducing means;
a selecting means for selecting a playlist, transferred to said data transmission section, from the playlists created by said playlist creating means;
an instructing means for instructing a start of a transfer of playlists; and
a transfer means for reproducing said data from said recording and reproducing means based upon an instruction from said instructing means in accordance with the playlist selected by said selecting means and transferring said playlist and said data through a network to said data transmission section.

2. A data transmission apparatus according to claim 1, wherein said plurality of data transmission sections are connected to said data creating section, being characterized in that
said selecting means selects playlists, transferred to said data transmission section, with respect to each of said plurality of data transmission sections and
said transfer means reproduces said data from said recording and reproducing means in accordance with the playlist selected by said selecting means and transfers said playlist and said data to each of said plurality of data transmission sections.

3. A data transmission apparatus according to claim 1, being characterized in that
said recording and reproducing means uses a nonlinear-accessible recording medium and said data transmission section includes recording and reproducing means using a nonlinear-accessible recording medium on which data transferred from said data creating section is recorded.

4. A data transmission apparatus according to claim 1, being characterized in that
said data creating section further includes a compression means for compressing data recorded on said recording and reproducing means and said data transmission section includes an expansion means for expanding data transferred from said data creating section.

5. A data transmission apparatus according to claim 1, being characterized in that
said data creating section further includes an edit information creating means for creating edit information for defining edit points obtained after data created by designating edit points has been edited and said transfer means transfers said edit information with respect to data on the playlist selected by said selecting means.

6. A data transmission method in which a data creating section for creating data to be transmitted and a data transmitting section for transmitting said created data are connected through a network, being characterized by comprising the steps of:
a first step of connecting a data creating section for creating data to be transmitted and a data transmission section for transmitting said data by a network and recording data thus created in said data creating section;
a second step of creating playlists for indicating a transmission schedule of data recorded at said first step by said data creating section;
a third step of selecting a playlist transferred to said data transmission section from the playlists created at said second step by said data creating section; and
a fourth step of reproducing the data recorded at said first step in accordance with the playlist selected at said third step and transferring said playlist and said data through said network to said data transmission section by said data creating section.

7. A data transmission method according to claim 6, in which said plurality of data transmission sections are connected to said data creating section, being characterized in that
said third step selects a playlist to be transferred to said data transmission section with respect to each of a plurality of said data transmission sections and said fourth step reproduces data recorded at said first step in accordance with the playlist selected at said third step with respect to each of said plurality of data transmission sections and transfers said playlists and said data.

8. A data transmission method according to claim 6, being characterized in that
said first step records data on a recording and reproducing means using a nonlinear-accessible recording medium and further includes a step of recording data transferred from the data creating section at said fourth step on a recording and reproducing means using a nonlinear-accessible recording medium by said data transmission section.

9. A data transmission method according to claim 6, being characterized by further comprising a step of compressing data recorded at said first step by said data creating section and
a step of expanding data transferred from said data creating section by said data transmission section.

10. A data transmission method according to claim 6, being characterized by further comprising a step of creating edit information for defining edit points obtained after data created by designating edit points has been edited by said data creating section and
said fourth step transfers said edit information with respect to data on the playlist selected at said third step.

11. A data transmission apparatus in which a playlist creating section for creating playlists for indicating a transmission schedule of data and a data transmission section for transmitting data based upon said playlists are connected together via a network, being characterized in that
said playlist creating section comprises:
an attribute imparting means for imparting attributes for instructing a transmission standby to playlists; and
a transfer means for transferring created playlists and information on said attributes imparted to said playlists and
said data transmission section comprises:
a time setting means for setting a time at which a transmission standby is effected; and
a transmission standby means for judging based upon said attribute information whether or not said attribute is imparted to the playlist transferred from said playlist creating section at a time set by said time setting means.

12. A data transmission apparatus according to claim 11, being characterized in that said transmission standby means judges every day whether or not a broadcasting start scheduled playlist is transferred from said playlist creating section within 24 hours from a time set by said time setting means, judges based upon information on said attribute whether or not said attribute is imparted to the playlist transferred from said playlist creating section and executes a transmission standby based upon the playlist whose broadcasting is to be started within 24 hours and to which said attribute is imparted.

13. A data transmission apparatus according to claim 11, being characterized by further comprising:
a transmission trigger setting means for setting a transmission trigger with respect to data added to the playlists and wherein said transfer means transfers information on the transmission trigger set by said transmission trigger setting means together with the playlists and
said transmission standby means further includes
a transmission starting means for judging the arrival of a transmission trigger based upon information on said transmission trigger with respect to data in which the transmission standby is executed by said transmission standby means and starts the transmission of said data.

14. A data transmission apparatus according to claim 11, being characterized in that
said playlist creating section further includes
a recording and reproducing means on which data is recorded,
a selecting means for selecting a playlist to be transferred to said data transmission section from among created playlists and
an instructing means for instructing the start of the transfer of the playlist,
said transfer means reproduces said data from said recording and reproducing means in accordance with the playlist selected by said selecting means based upon the instruction from said instructing means and transfers said playlist and said data through a network and
said data transmission section further includes
a recording and reproducing means for recording data transferred from said playlist creating section.

15. A data transmission apparatus according to claim 14, being characterized in that said recording and reproducing means in said playlist creating section and said recording and reproducing means in said data transmission section use nonlinear-accessible recording mediums, respectively.

16. In a transmission standby method for a data transmission apparatus in which a playlist creating section for indicating a transmission schedule of data and a data transmission section for transmitting data based upon said playlist are connected together via a network and in which
said data transmission section includes
a time setting means for setting a time at which a transmission standby is executed and
a transmission standby means for judging whether or not an attribute for instructing a transmission standby is imparted to a playlist at a time set by said time setting means,
said transmission standby method being characterized by comprising the steps of:
a first step of imparting said attribute to the playlist by said playlist creating section;
a second step of transferring the created playlist and information on said attribute imparted to said playlist at said first step by said playlist creating section; and
a third step of setting a time for a transmission standby by said time setting means in said data transmission section.

17. A transmission standby method according to claim 16, being characterized in that said transmission standby means judges every day whether or not there exists a playlist whose broadcasting is to be started within 24 hours from the time set by said time setting means, judges whether or not said attribute is imparted to the playlist and executes a transmission standby based upon the playlist whose broadcasting is to be started within 24 hours and to which said attribute is imparted.

18. A transmission standby method according to claim 16, being characterized by further comprising:
a step of setting a transmission trigger with respect to data added to the playlist in said playlist creating section;
a step of transferring information on said transmission trigger together with the playlist at said second step; and
a step of judging based upon information on said transmission trigger the arrival of a transmission trigger with respect to data on which a transmission standby is effected and starting the transmission of said data in said data transmission section.

19. A transmission standby method according to claim 16, being characterized by further comprising the steps of:
a step of recording data in said playlist creating section;
a step of selecting a playlist transferred to said data transmission section from among the created playlists in said playlist creating section;
a step of reproducing said recorded data in accordance with said selected playlist and transferring said playlist and said data through said network to said data transmission section by said playlist creating section; and
a step of recording data transferred from said playlist creating section in said data transmission section.

20. A transmission standby method according to claim 19, being characterized in that said playlist creating section and said data transmission section respectively record data on recording and reproducing means using nonlinear-accessible recording mediums.

21. A transmission standby apparatus being characterized by comprising:
a playlist creating means for creating playlists indicative of a transmission schedule of data;
an attribute imparting means for imparting an attribute for instructing a transmission standby to said playlists;
a time setting means for setting a time at which a transmission standby is executed; and
a transmission standby means for judging whether or not said attribute is imparted to the playlist created by said playlist creating means at a time set by said time setting means and executing a transmission standby based upon the playlist to which said attribute is imparted.

22. A transmission standby apparatus according to claim 21, being characterized in that said transmission standby means judges every day whether or not a playlist whose broadcasting is to be started within 24 hours from a time set by said time setting means is created by said playlist creating means, judges whether or not said attribute is imparted to the playlist created by said playlist creating means and executes a transmission standby based upon a playlist whose broadcasting is to be started within 24 hours and to which said attribute is imparted.

23. A transmission start apparatus being characterized by comprising:
a playlist creating means for creating a playlist indicative of a transmission schedule of data;
an attribute imparting means for imparting an attribute for instructing a transmission standby to said playlist;
a transmission trigger setting means for setting a transmission trigger with respect to data added to said playlist;
a time setting means for setting a time at which a transmission standby is executed;
a transmission standby means for judging whether or not said attribute is imparted to the playlist created by said playlist creating means at a time set by said time setting means and executing a transmission standby based upon the playlist to which said attribute is imparted; and
a transmission starting means for judging the arrival of the transmission trigger set by said transmission trigger setting means with respect to data in which a transmission standby is executed by said transmission standby means and starting the transmission of said data.

24. A transmission start apparatus according to claim 23, being characterized in that said transmission standby means judges every day whether or not a playlist whose broadcasting is to be started within 24 hours from a time set by said time setting means is created by said playlist creating means, judges whether or not said attribute is imparted to the playlist created by said playlist creating means and executes a transmission standby based upon the playlist whose broadcasting is to be started within 24 hours and to which said attribute is imparted.

25. A transmission start apparatus according to claim 24, being characterized by further comprising:
a recording and reproducing means using a nonlinear-accessible recording medium and wherein
said playlist creating means creates said playlist with respect to data recorded on said recording and reproducing means and
said transmission starting means reproduces data whose transmission is started from said recording and reproducing means.

26. In a transmission standby method for a data transmission system comprising:
a playlist creating means for creating playlists indicative of a transmission schedule of data;
a time setting means for setting a time at which a transmission standby is executed;
a transmission standby means for judging whether or not an attribute for instructing a transmission standby is imparted to the playlist created by said playlist creating means at a time set by said time setting means and executing a transmission standby based upon the playlist to which said attribute is imparted; and
a transmission means for transmitting data,
said transmission standby method being characterized by comprising the steps of:
a first step of imparting said attribute to the playlist created by said playlist creating means; and
a second step of setting a time at which the transmission standby is executed by said time setting means.

27. A transmission standby method according to claim 26, being characterized in that said transmission standby means judges every day whether or not there exists a playlist whose broadcasting is to be started within 24 hours from a time set by said time setting means, judges whether or not an attribute for instructing a transmission standby is imparted to the playlist and executes a transmission standby based upon the playlist whose broadcasting is to be started within 24 hours and to which said attribute is imparted.

28. In a transmission start method for a data transmission system which is comprised of:
a playlist creating means for creating a playlist indicative of a transmission schedule of data;
a time setting means for setting a time at which a transmission standby is executed;
a transmission standby means for judging whether or not an attribute for instructing a transmission standby is imparted to a playlist created by said playlist creating means at a time set by said time setting means and executing a transmission standby based upon the playlist to which said attribute is imparted; and
a transmission means for transmitting data,
said transmission start method being characterized by comprising the steps of:
a first step of imparting said attribute to a playlist;
a second step of setting a transmission trigger with respect to data added to said playlist;
a third step of setting a time at which a transmission standby is executed by said time setting means; and
a fourth step of judging based upon information on said transmission trigger whether or not the transmission trigger arrives with respect to data in which a transmission standby is executed by said transmission standby means and starting the transmission of said data.

29. A transmission start method according to claim 28, being characterized in that said transmission standby means judges every day whether or not there exists a playlist whose broadcasting is to be started within 24 hours from a time set by said time setting means, judges whether or not an attribute for instructing a transmission standby is imparted to a playlist and executes the transmission standby based upon the playlist whose broadcasting is to be started within 24 hours and to which said attribute is imparted.

30. A transmission start method according to claim 29, wherein said playlist creating means creates said playlist with respect to data recorded on a recording and reproducing means using a nonlinear-accessible recording medium and said fourth step reproduces transmission starting data from said recording and reproducing means.
